(19) United States
(12) Patent Application Publication
(10) Pub. No.: US 2011/0128575 A1
(43) Pub. Date: Jun. 2, 2011

(54) DISPLAY APPARATUS, IMAGE FORMING APPARATUS AND COMPUTER READABLE INFORMATION RECORDING MEDIUM

(75) Inventor: Yoshiko IWATA, Kanagawa (JP)

(73) Assignee: RICOH COMPANY, LTD.

(21) Appl. No.: 12/952,252

(22) Filed: Nov. 23, 2010

(30) Foreign Application Priority Data
Nov. 27, 2009 (JP) NO.2009-270491

(51) Int. Cl. G09G 5/00; G06F 3/12

(52) U.S. Cl. 358/1.15; 345/156

(57) ABSTRACT

A display apparatus displays a list of functions for application software; stores one or more display modes for disposing setting information in a display component for each of the functions; receives the selected function, generates the one or more display modes of the display component of the function while disposing the setting information in the one or more display modes of the display component and generates a display mode list screen that displays a list of the one or more display modes of the display component of the function; and receives the display mode selected from the display mode list screen, and displays, based on size information of the display component of the display mode, a disposing place candidate for disposing the display component of the display mode on a screen on which the display component of the display mode is to be disposed.

### BACKGROUND OF THE INVENTION

1. Field of the Invention

The present invention relates to a display apparatus and so forth that display operating keys, and in particular, a display apparatus, an image forming apparatus and a computer readable information recording medium in which a user can customize the operating keys.

2. Description of the Related Art

A user interface (simply abbreviated as UI, hereinafter) is known which displays various operating keys on a display apparatus that uses a liquid crystal display or such and receives a user's operation through a touch panel, a pointing device or such. In a case of a PC (Personal Computer) using a display apparatus having the relatively large number of pixels, many operating keys (soft keyboard) can be displayed together, and therefore, needs for effective utilization of a screen are not so large. In contrast thereto, in a case of a built-in type apparatus for example, while the number of operating keys to be displayed on one screen increases as required functions become diversified, a sufficient increase in a size of a display apparatus may not be allowed. As an example of a built-in type apparatus, a printer, a copier, a facsimile machine, a scanner apparatus, a MFP (Multi-Function Peripheral, referred to as an image forming apparatus, hereinafter) that performs one or more of these functions, a navigation apparatus, a cellular phone or such, may be cited.

Manufacturers consider sizes and dispositions of operating keys for the purpose of disposing many operating keys in a limited display area while keeping a user friendly UI. However, it may be physically difficult to dispose all the operating keys that a user can operate in one screen.

Further, even in a case where all the operating keys that a user can operate can be disposed in a screen, there may be a case where it may not be necessary to dispose all the operating keys that a user can operate, because only some of the operating keys correspond to functions that the user frequently uses.

A display apparatus is known in which each user can customize a UI (for example, see Japanese Laid-Open Patent Application No. 2007-249863). Japanese Laid-Open Patent Application No. 2007-249863 discusses an image forming apparatus in which a list of operating keys corresponding to functions, which can be disposed on a screen, is displayed, operating keys selected from the list by a user are disposed at desired positions, and thus, customizing is achieved.

However, dispositions of functions can be customized, but customizing of setting values that can be set for each function is not considered, in the image forming apparatus discussed by Japanese Laid-Open Patent Application No. 2007-249863. Therefore, although positions to dispose functions and the number of the functions to dispose can be customized, it may be difficult to customize the number and/or the contents of setting values that can be set for each function. Further, according to Japanese Laid-Open Patent Application No. 2007-249863, functions can be disposed freely one by one, and therefore, a degree of freedom in customizing is high. However, on the other hand, a user may feel that customizing is troublesome.

### SUMMARY OF THE INVENTION

According to an embodiment of the present invention, a display apparatus that displays, in a display component for a function that can be called from application software, setting information that can be set for the function, includes a function list display part that displays a list of functions for the application software; a display information storing part that stores display mode information that indicates one or more display modes for disposing the setting information in the display component for each of the functions; a first screen generating part that receives the function selected from the list of functions, generates the one or more display modes of the display component based on the display mode information that is associated with the function and is read from the display information storing part while disposing the setting information in the one or more display modes of the display component according to the display mode information, and generates a display mode list screen that displays a list of the one or more display modes of the display component of the function; and a disposing place candidate display part that receives a display mode selected from the display mode list screen, and displays, based on size information of the display component of the display mode, a disposing place candidate for disposing the display component of the display mode on a screen on which the display component of the display mode is to be disposed.

Other objects, features and advantages of the embodiment of the present invention will become more apparent from the following detailed description when read in conjunction with the accompanying drawings.

### BRIEF DESCRIPTION OF THE DRAWINGS

FIG. 1 generally illustrates one example of a feature of a display apparatus;

FIGS. 2A, 2B and 2C illustrate one specific example of customizing;

FIG. 3 shows one example of a hardware configuration of an image forming apparatus;

FIG. 4 shows one example of an operation panel;

FIG. 5 shows one example of a software configuration of the image forming apparatus;

FIG. 6 shows one example of a block diagram of the display apparatus;

FIG. 7 shows one example of user information stored in a user information storing part;

FIGS. 8A and 8B show one example of customizing data;

FIG. 9 schematically shows one example of graphic data;

FIGS. 10A and 10B show one example of setting value display order data;

FIG. 11 shows one example of install data;

FIG. 12 shows one example of transition of screens (an operating screen and a function list screen) displayed on an operation panel when a user customizes a UI;

FIG. 13 shows one example of transition of screens (a view selection screen, and a display order selection screen) displayed on the operation panel when the user customizes the UI;

FIG. 14 shows one example of transition of screens (a disposing place selection screen and a customizing result confirmation screen) displayed on the operation panel when the user customizes the UI;

FIG. 15 shows one example of a sequence diagram of a procedure in which a customizing function selecting part 62 displays an easy copy operating screen 201 and then a function list screen 202 of FIG. 12;

FIGS. 16 and 17 show one example of a sequence diagram of a procedure in which a view selecting part and so forth display the function list screen 202 of FIG. 12 and then a view selection screen 203 of FIG. 13;

FIG. 18 illustrates one example of details of a process of step S300;

FIG. 19 shows one example of a sequence diagram of a procedure in which a setting value order change selecting part and so forth display the view selection screen 203 and then a display order selection screen 204 of FIG. 13;

FIG. 20 shows one example of a sequence diagram of a procedure in which screen disposing place selecting part and so forth display a disposing place selection screen 205 and then a customizing result confirmation screen 206 of FIG. 14; and

FIG. 21 generally shows one example of a configuration of a customizing system in which the image forming apparatus and a PC are connected together.

### DETAILED DESCRIPTION OF THE EMBODIMENTS

Below, an embodiment of the present invention will be described with reference to figures.

According to the embodiment, in consideration of the above-mentioned points, an object is to provide a display apparatus, an image forming apparatus, a customizing method and a computer readable information recording medium, by which it is possible to customize settings concerning one function in such a manner that a UI that a user can easily use is achieved.

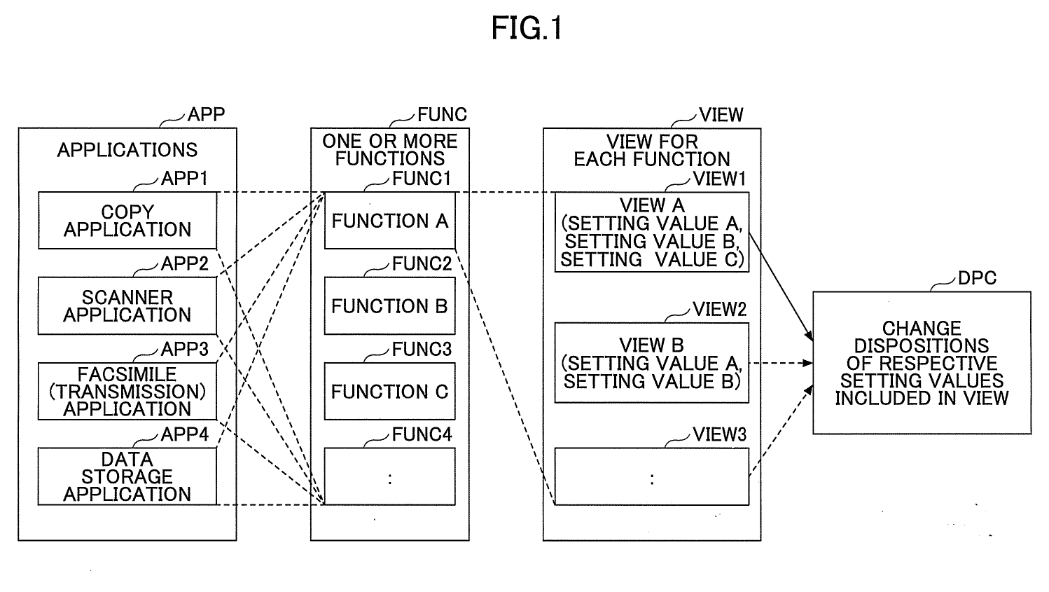

FIG. 1 generally shows one example of a feature of a display apparatus 100 in the embodiment. In an image forming apparatus 200 that has the display apparatus, plural applications are mounted. An “application” means software that provides a sequence of processes for a combination of one of plural input parts that the image forming apparatus 200 has and one of plural output parts that the image forming apparatus 200 has. There are various applications. FIG. 1 shows, as examples of applications APP, a copy application APP1, a scanner application APP2, a facsimile (transmission) application APP3 and a data storage application APP4. For example, an input part for the copy application APP1 is a scanner engine that reads an original, and an output part for the copy application APP1 is a print engine that prints a thus-read image onto a paper medium. Further, for example, an input part for the scanner application APP2 is the scanner engine that reads an original, and an output part for the scanner application APP2 is a storage device that stores thus-read image data. Thus, the image forming apparatus 200 can provide various functions corresponding to the applications by using respective combinations of input parts and output parts.

Internally, as will be described later with reference to FIG. 5, control services and so forth and a platform are provided, which plural applications can use in common, between the applications and hardware resources that include the plural input parts and the plural output parts. The control services and the platform provide various services such as controlling screens of an operation panel, management of the hardware, execution control and so forth. A user selects, from an operating screen that is different for each application, a function that can be used from the application, but the user need not be aware of the control services that operate internally.

For each function, settings can be carried out by a user to designate further detailed operations. Therefore, on the operating screen provided for the application, setting values for each of the function A, function B, function C, . . . (FUNC: FUNC1, FUNC2, FUNC3, FUNC4, . . . ) (simply referred to as “functions” in a case of a generalization, hereinafter) that can be used from the application are displayed. The setting values are parameters that a user can set for each function. For example, in a case where the function is “color selection”, typical setting values are “monochrome”, “full color”, “two colors”, “single color” and “automatic color selection”. The setting values may be expressed, for example, as information that controls an output result when output is carried out by the application by using the function.

Therefore, when the function and the setting values are displayed in such a manner that they are united, a user can visually understand how to operate, and usability may improve. In the embodiment, an icon that displays a function and setting values in such a manner that they are united (all of a lump) is referred to as a “view”. The age forming apparatus 200 in the embodiment allows a user to select one view from among plural views for one function, and also, to customize dispositions of setting values of the selected view.

For example, in a case where the copy application APP1 uses the function A FUNC1 in FIG. 1, a user can select a view for the function A from among a view A, view B, . . . (VIEW: VIEW1, VIEW2, VIEW3, . . . ) (simply referred to as “views” in a case of a generalization, hereinafter). The number of setting values that are displayed as being selectable for each view may be different, and also, even in a case where the number of setting values is the same, one or more of the setting values that are displayed may be different (the same setting value may be disposed in one view). For example, the view A VIEW1 has three setting values, i.e., a setting value A, a setting value B and a setting value C, while the view B VIEW2 has two setting values, i.e., the setting value A and the setting value B.

A user may change (customize) dispositions of respective setting values included in the view A, view B or such (DPC in FIG. 1). For example, the user may customize the order to dispose the setting values of the view A as, from the top, the stated order of the setting value A, the setting value B, and the setting value C, or, from the bottom, the stated order of the setting value C, the setting value B and the setting value A.

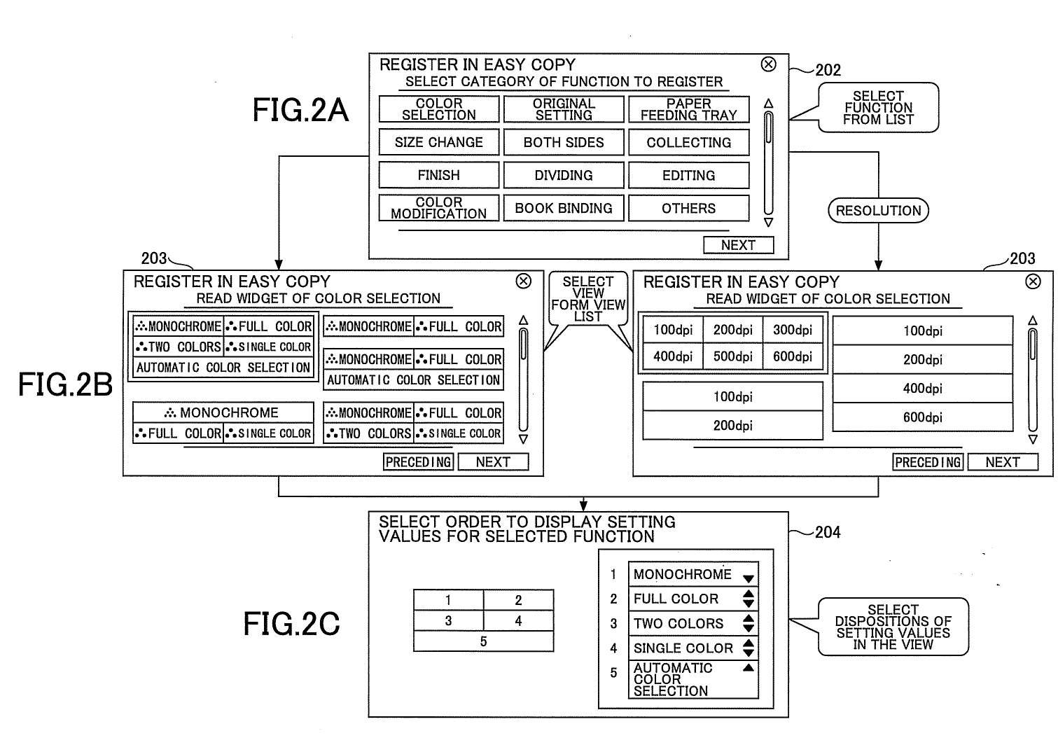

FIGS. 2A, 2B and 2C illustrate a specific example of customizing. FIG. 2A shows one example of a list of functions that the copy application has (function list screen 202). The left of FIG. 2B shows one example of a list of views for the function “color selection” (view selection screen 203). FIG. 2C illustrates one example of customizing dispositions of setting values in one view (display order selection screen 204).

As shown on the left side of FIG. 2B, five views are prepared for “color selection” (it is also possible to display views more than the five by scrolling the screen). A user can select a desired view from among the five views. In a case where the user selects the top left view (including setting values, i.e., “monochrome”, “full color”, “two colors”, “single color” and “automatic color selection”), the selected view includes the five setting values.

Therefore, in FIG. 2C, the view is separated into five areas (1, 2, 3, 4 and 5), and a user can select the setting values to be disposed at respective areas. Thus, a user can select a view for each function, and further, customize dispositions of setting values included in the selected view. Thus, customizing in the embodiment includes selection of a view and change of dispositions of setting values. However, a user may carry out customizing of only any one of selection of a view and change of disposition of setting values.

It is noted that, on the right side of FIG. 2B, the view selection screen 203 is displayed in a case where a user has selected “resolution” that is a function frequently used in the scanner application. Thus, the user can select a view for each function.

The display apparatus 100 can display only setting values that a user frequently uses for each function, and also, necessarily dispose setting values for the same function at mutually close positions. Further, it is possible to change dispositions of setting values for a selected view. Therefore, it is possible that plural setting values are disposed at such positions that a user can easily use.

### [Image Forming Apparatus 200]

The image forming apparatus 200 will now be described. In the embodiment, customizing of a screen for an example of the display apparatus 100 mounted in the image forming apparatus 200 will be described. However, the display apparatus 100 in the embodiment may also be preferably mounted in an apparatus for which a size of a screen is restricted (for example, a car navigation apparatus, a cellular phone, a Smartphone, a PDA (Personal Digital Assistant), a music player or such).

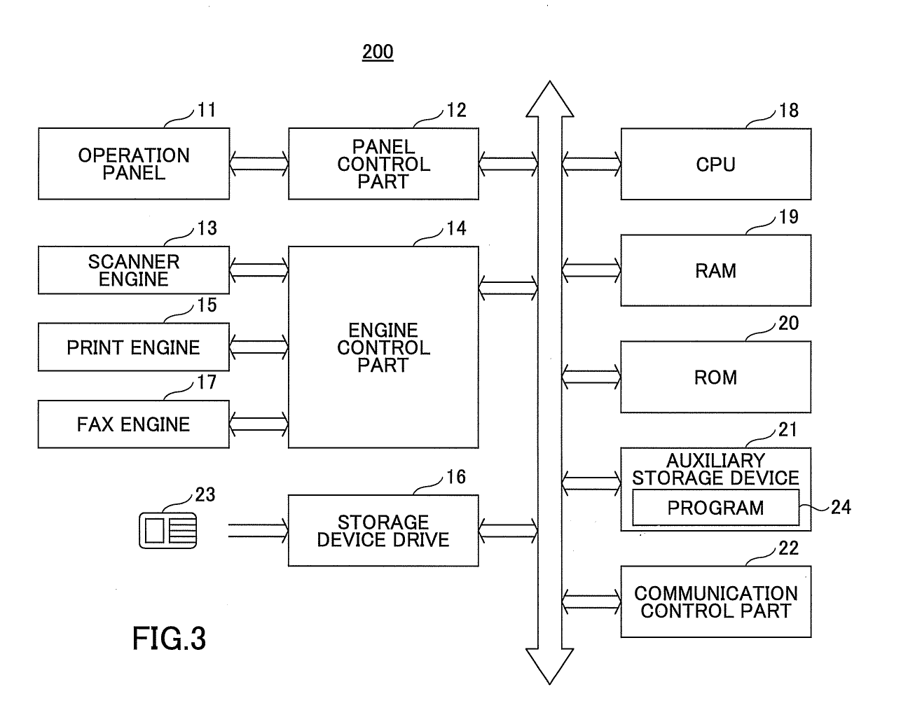

FIG. 3 shows one example of a hardware configuration of the image forming apparatus 200. The image forming apparatus 200 includes a CPU 18, a panel control part 12, an engine control part 14, a storage device drive 16, a communication control part 22, an auxiliary storage device 21, a ROM 20 and a RAM 19 which are mutually connected by a bus. An operation panel 11 is connected to the panel control part 12, and a scanner engine 13, a print engine 15 and a FAX engine 17 are connected to the engine control part 14.

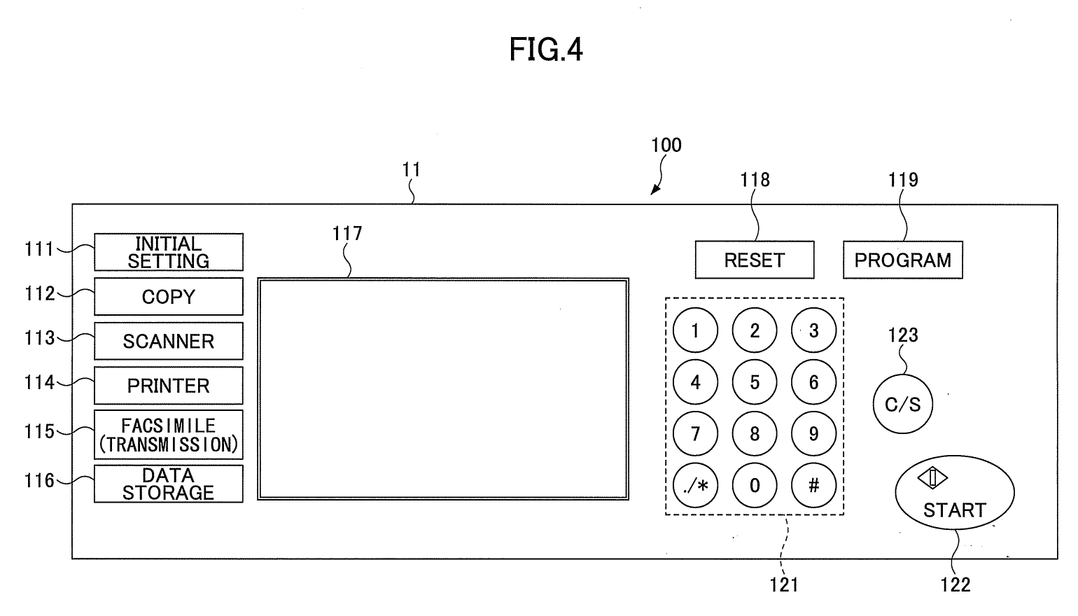

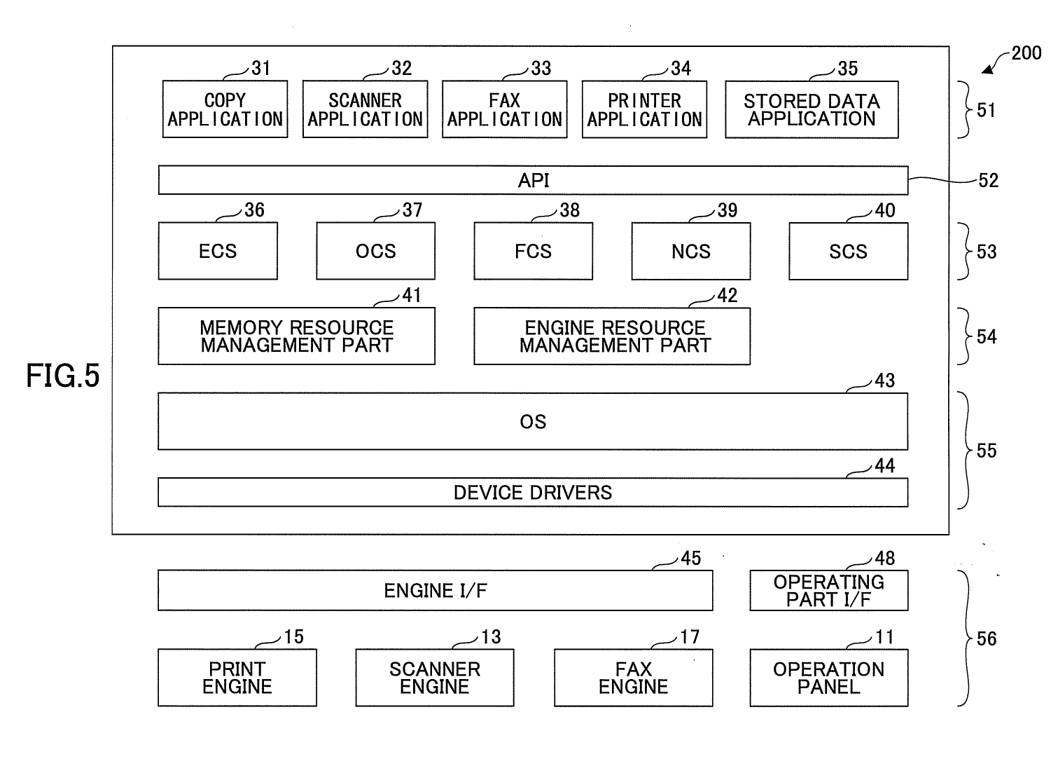

The operation panel 11 mainly has hard keys and a touch panel (described later with reference to FIG. 4), and the panel control part 12 receives a user's operation carried out on the operation panel 11, and displays various screens on the touch panel.

The scanner engine 13 irradiates an original (paper or such) through a contact glass (not shown) by means of a light source (not shown), and converts reflected light from the original into digital data by means of a photoelectric converter such as a CCD (Charge Coupled Device) (not shown) through an optical system (not shown) including mirrors and lenses. Thus-obtained image data in a form of the digital data of the original is processed (image processing) by processes carried out by an ASIC (Application Specific Integrated Circuit) (not shown) and/or the CPU 18 based software.

The print engine 15 transfers a toner image formed from the image data onto a paper sheet by means of a photosensitive drum that is an image carrying member, a charging unit that charges the photosensitive drum, an exposure unit that exposes the photosensitive drum, a developing unit and a cleaning unit (which are not shown), and fixes the toner image onto the paper sheet by means of a fixing unit (not shown).

The FAX (facsimile) engine 17 demodulates facsimile data received from a telephone line to generate image data and stores the image data in the auxiliary storage device 21, and, while the FAX (facsimile) application has been started up, modulates image data read through the scanner engine 13 for facsimile transmission, and outputs the modulated image data to the telephone line. An IP (Internet Protocol) network may be used instead of the telephone line for the facsimile transmission and reception.

The storage device drive 16 reads data from a recording medium 23, and writes data received from the CPU 18 in the recording medium 23. The recording medium 23 may be a semiconductor memory such as a memory card employing a flash memory, an optical disk such as a CD-ROM (Compact Disk Read Only Memory), or such.

The communication control part 22 is, for example, an Ethernet (registered trademark) card, and transmits data according to HTTP (Hyper Text Transport Protocol) or such to a router that is connected to a communication network. The router carries out routing of the data based on an IP address that the data includes to a server or such that is a destination of the data.

The ROM 20 stores a program for starting up an OS (Operating System), an I/O (Input and Output) system and so forth. The auxiliary storage device 21 is, for example, a hard disk drive, a flash drive, or such, and stores the applications, the platform including the OS, device drivers, and a program 24 for customizing operating screens. The RAM 19 is a work memory that is used by the CPU 18 to execute the OS and the program 24, and is used as a temporary storage area.

The program 24 may be, in many cases, shipped together with the image forming apparatus 200 in a state in which the program 24 is stored in the auxiliary storage device 21. However, it is also possible to distribute a part or all of the program 24 in a state in which the part or all of the program 24 is stored in the recording medium 23. Further, the program 24 may be distributed in a mode in which the program 24 is installed in the auxiliary storage device 21 after being received from a server (not shown) by means of the communication control part 22.

FIG. 4 shows one example of the operation panel 11. The operation panel 11 includes, as fixed hard keys, an initial setting key 111, a copy key 112, a scanner key 113, a printer key 114, a facsimile key 115, a data storage key 116, a ten-key 121, a reset key 118, a program key 119, a clear/stop key 123, and a start key 122. The operation panel 11 further includes a liquid crystal display part 117. The liquid crystal display part 117 includes the touch panel together as being united, and operating keys as soft keys are formed corresponding to various screens in the touch panel. The initial setting key 111 is used by a user to set whether to display icons on an operating screen for each application, and carry out various settings such as activating/deactivating an authentication function.

The copy key 112, the scanner key 113, the facsimile key 115 and the data storage key 116 are keys used to switch the respective applications. The ten-key 121 is used by a user to input the number of printing copies, a facsimile telephone number and so forth. The reset key 118 is used to return a setting value that is set for operating for each application into an initial value. The program key 119 is used to register, call or delete a program in or from the image forming apparatus 200. The clear/stop key 123 is used to cancel an input numeric value, or interrupt reading or printing. The start key 122 is an execution key used to start a copying operation, a facsimile transmission, or such.

FIG. 5 shows one example of a software configuration of the image forming apparatus 200. The image forming apparatus 200 includes the applications 51, an API (Application Programming Interface) 52, control services 53, a resource management part 54, the platform 55 and hardware resources 56.

The applications 51 include the above-mentioned copy application 31, the scanner application 32, the FAX application 33, the printer application 34 and the data storage application 35. Other than these, a Web application, a network application and so forth may be included in the applications 51. Respective processes of the applications 51 and respective processes of the control services 53 call functions, obtain returned values in response to calling the functions, carry out inter-process communications by means of transmitting and receiving messages, and provide services such as a copy service, a scanner service, a facsimile service, a data storage service and so forth.

Further, the control services 53 include respective processes of an ECS (engine control service) 36, an OCS (operation panel control service) 37, a FCS (FAX control service) 38, a NCS (network control service) 39 and a SCS (system control service) 40. A process of the ECS 36 controls the print engine 15, the scanner engine 13 and the FAX engine 17 connected with the ECS 36 via an engine I/F 45. A process of the OCS 37 controls the operation panel 11 that acts as an information transferring part between a user and the image forming apparatus 200. The process of the OCS 37 obtains operations of hard keys or soft keys from the operation panel 11 as key events, and notifies the SCS 40 of key event functions corresponding to the key events. A process of the FCS 38 provides interfaces for facsimile transmission and reception by using PSTN/ISDN networks, registration/citation of various facsimile data stored in the auxiliary storage device, reading image data for transmission, printing received facsimile data, and so forth. A process of the NCS 39 provides communication services in common to the applications 51 that carry out transmission and reception by using the network. For example, the process of the NCS 39 receives data from the applications 51, requests the communication control part 22 to transmit the received data to the network, and distributes data that the communication control part 22 has received from the network to the applications 51. Further, the image forming apparatus 200 may have respective processes of a user information control part that manages user information, a user authentication management part that manages user authentication, a file control part that carries out control of registration, delivery, deletion, moving and so forth of document data or files stored in the auxiliary storage device 21.

Further, the process of the SCS 40 carries out application management, session management, system screen display, LED display, resource management, application control by using interrupts, and so forth. Further, the SCS 40 calls a drawing function based on an event function reported by the CCS 37 and draws various screens on the operation panel 11, and further calls the drawing function in response to a request from the application 51 or the control service 53 and draws various screens on the operation panel 11.

A memory resource management part 41 monitors a usage state of the RAM 19, and carries out releasing or reserving the RAM 19. An engine resource management part 42 carries out, together with the SCS 40, arbitration of requests given by the upper layers that use the hardware resources 56, and controls execution of the requests. The engine resource management part 42 determines whether the requested hardware resources 56 are available, and informs the upper layers of a result of the determination if the hardware resources 56 are available.

The applications 51 request the functions from the control services 53 via the API 52. The control services 53 interpret the requests from the applications 51, and generate acquisition requests for the hardware resources 56. The memory resource management part 41 or the engine resource management part 42 arbitrates the acquisition requests. Further, an OS (for example, LINUX (registered trademark)) 43 executes respective parts of software of the applications 51 and the control services 53 as the processes in parallel.

Further, device drivers 44 use the engine I/F 45 and an operating part I/F 48, and request the hardware resources 56 to carry out processing. By the above-described configuration, the image forming apparatus 200 can unitarily carry out processing that is necessary in common for the respective applications 51 by means of the processes such as the control services 53 and those provided below the control services 53 in FIG. 5.

### [Function of Display Apparatus]

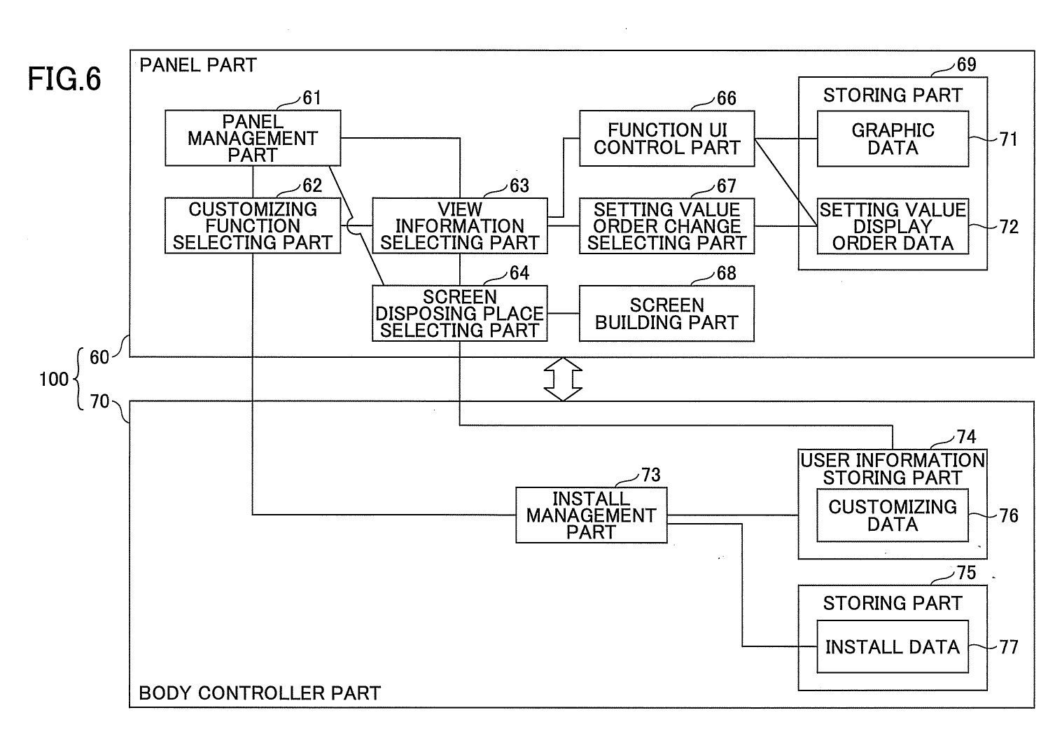

FIG. 6 shows one example of a functional block diagram of the display apparatus 100 in the embodiment. As shown in the functional block diagram of FIG. 6, the display apparatus 100 includes a panel part 60 and a body controller part 70. The panel part 60 mainly corresponds to the operation panel 11 and the panel control part 12 of the image forming apparatus 200 shown in FIG. 3 that includes the display apparatus 100, and the body controller part 70 mainly corresponds to the CPU 18 or ASIC not shown of the image forming apparatus 200.

The panel part 60 includes a panel management part 61, a customizing function selecting part 62, a view information selecting part 63, a screen disposing place selecting part 64, a function UI control part 66, a setting value order change selecting part 67 and a screen building part 68, which are realized as a result of the CPU 18 executing the program 24. Further, a storing part 69 is actually achieved by the auxiliary storage device 21 shown in FIG. 3, and includes graphic data 71 and setting value display order data 72.

The panel management part 61 receives a user's operation. That is, the panel management part 61 receives identification information of the hard keys that the user presses, identification information of the soft keys, or positional information of positions where the user presses.

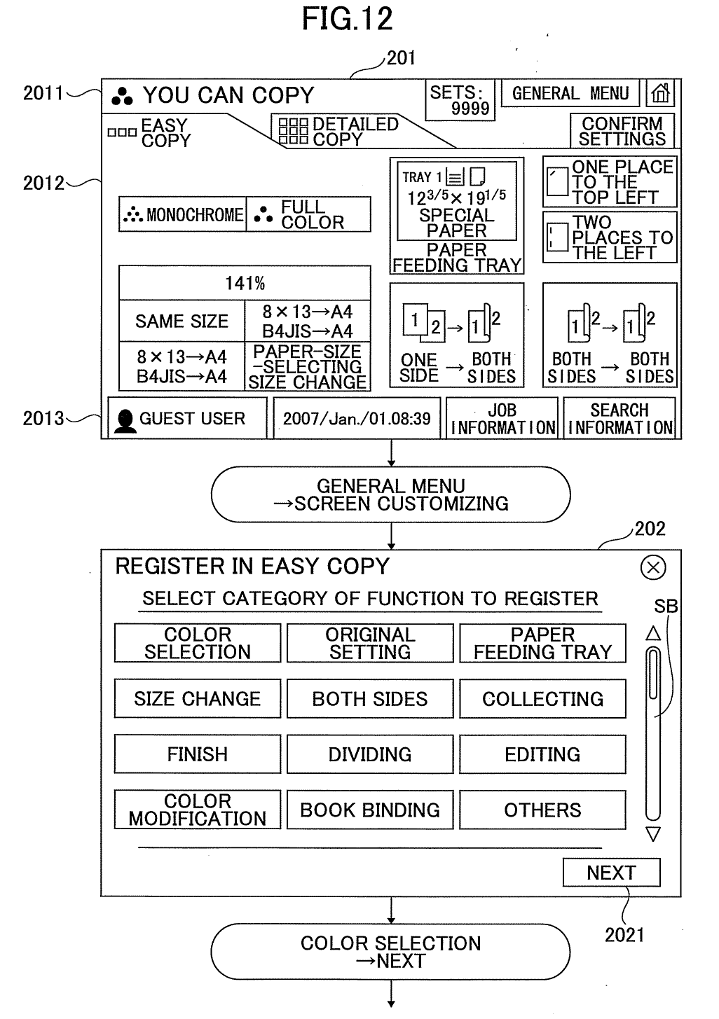

The customizing function selecting part 62 displays the function list screen 202 (see FIG. 2A. and FIG. 12) on the operation panel 11, which screen displays a list of functions to which customizing is to be carried out to be selected by a user. For this purpose, the customizing function selecting part 62 uses install data 77 and the user information, and obtains the functions to be customized from the install management part 73. It is noted that the customizing function selecting part 62 holds, by means of a flag or such, a fact that the functions are in states of having been called, i.e., that a user is now customizing the operating screen 201 (see FIG. 12), and turns off the flag when the user has finished the customizing of the operating screen 201. Thereby, the respective functional blocks can determine whether the display apparatus 100 is in a regular operation or in a state of currently being customized.

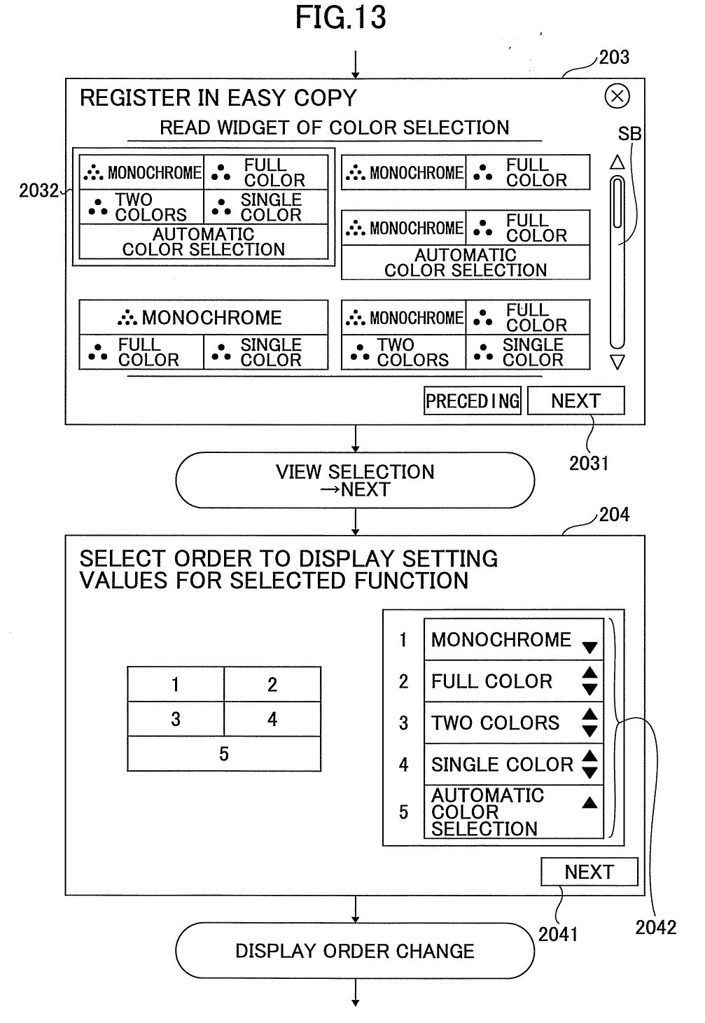

The view information selecting part 63 provides a function concerning generation and display of the views. Specifically, the view information selecting part 63 generates the functional UI control part 66 corresponding to the functions, the function UI control part 66 generates outlines of “view components” described below from the graphic data, and generates the respective views by disposing setting values at respective areas of each view. Therefore, the function UI control part 66 stores the graphic data 71 and the setting value display order data 72 of the respective view components. Further, the view information selecting part 63 generates the view selection screen 203 (see FIG. 2B and FIG. 13), and receives a user's view selection. It is noted that the view information selecting part 63 can prepare a screen for each function selected via the customizing function selecting part 62.

The view information selecting part 63 is not only used for customizing the operating screen 201 but also used for a regular operation, i.e., the view information selecting part 63 also operates to receive selections of the setting values of each view from the operating screen 201 in each application. Therefore, it is not necessary to newly mount a view information selecting part 63, for the operating screen 201, which is used only for customizing the operating screen 201. Thus, it is possible to reduce a cost increase, and to shorten a developing time period. Further, the views the same as those (appearances) displayed on the operating screen 201 are also displayed during customizing operations. Therefore, customizing that is easy for a user to understand can be provided.

The setting value change selecting part 67 provides a function concerning a change of an order to display setting values for a function to be customized. The display order that a user has changed is stored as “the setting value display order data”.

The screen disposing place selecting part 64 determines where to dispose the view of the function to be customized on the operating screen 201. The screen disposing place selecting part 64 displays a candidate of a place at which the view is to be disposed based on size information of the view.

The screen building part 68 builds the screen by disposing views of the respective functions in such a manner that the views do not overlap with each other.

The body controller part 70 has the install management part 73 realized as a result of the CPU 18 executing the program 24. Further, a user information storing part 74 and a storing part 75 are actually realized by the auxiliary storage device 21, the user information storing part 74 has customizing data 76 and history data (not shown), and the storing part 75 has the install data 77.

The install management part 73 manages, for each of the applications 51, the functions installed in the image forming apparatus 200, as the install data 77.

The user information storing part 74 stores information concerning users. The graphic data 71 is data that is used for generating the view components by the function UI control part 66, and prescribes views' shapes, sizes, area dividing, correspondence information between the areas thus divided and the numbers identifying the areas, and so forth. The setting value display order data 72 is data recording a priority order between the respective setting values used when the setting values are displayed for each function as the view. The setting values are given the numbers according to the priority order, and a user can determine a display order by associating the numbers identifying the areas of the view component with the numbers of the setting values. As mentioned above, the setting value display order data 27 may include a customizing result. The customizing data 76 is data including a screen customizing result for each user, and, specifically, includes link information to the setting value display order data 72, and view place information (the place to depose the view on the operating screen). It is noted that the storing places of the respective data mentioned above are merely examples.

### [For Respective Data]

Below, data that the display apparatus 100 in the embodiment processes will be described.

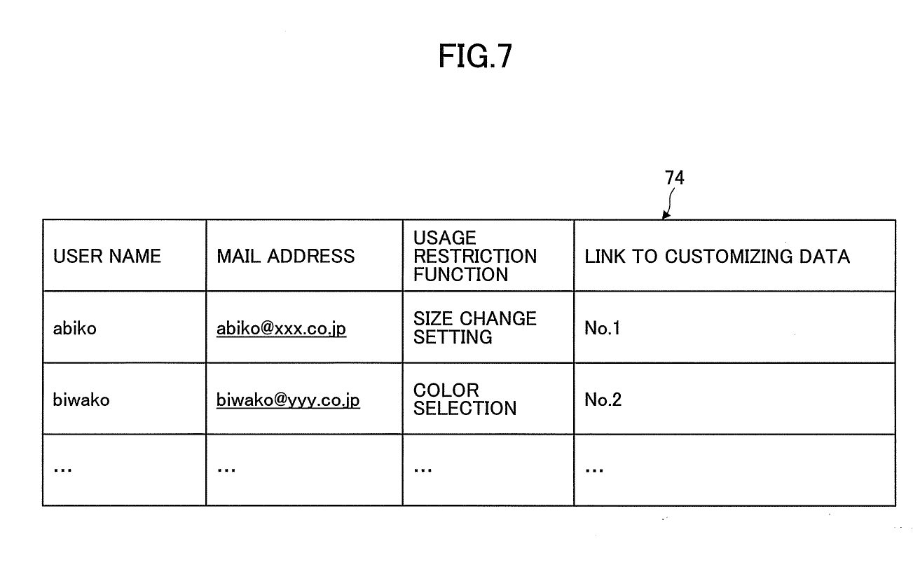

FIG. 7 shows one example of the user information stored by the user information storing part 74. As the user information, the following data is registered associated with a user name: “mail address”, “usage restriction function”, “link to customizing data”, and so forth. “Mail address” is used for transmitting various information items to the user, and may be an IP address or such. “Usage restriction function” is a function for which the user's usage is not allowed. “Link to customizing data” is a place at which the user's customizing data 76 is stored in a case where the user has customized the operating screen 201 as described later. In the example of FIG. 7, “link to customizing data” of the user “abiko” is “No 1”, and “link to customizing data” of the user “biwako” is “No 2”. One user may have links to plural items of the customizing data 76.

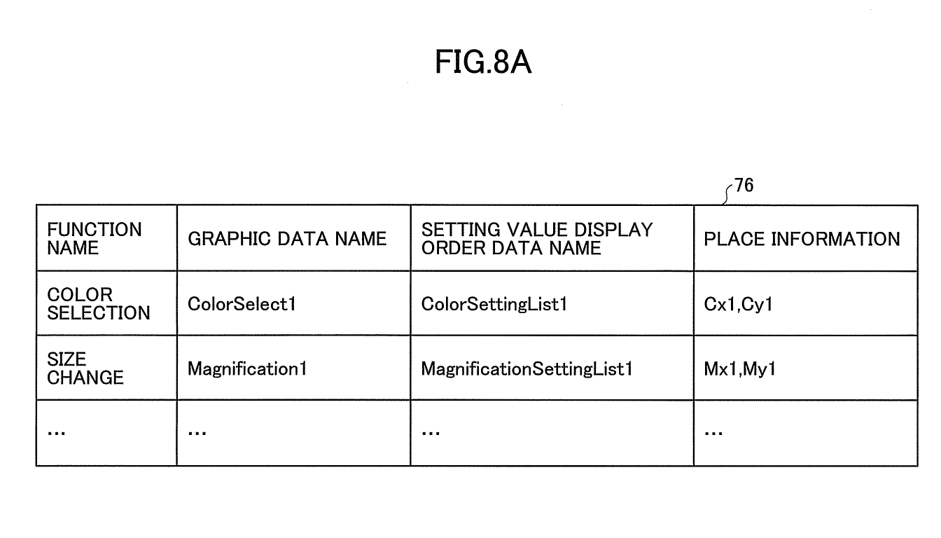

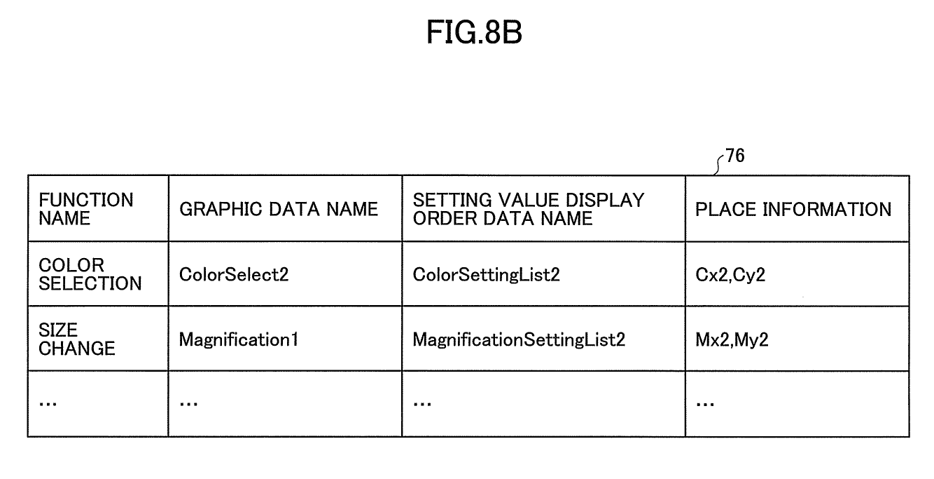

FIGS. 8A and 8B show examples of the customizing data 76. FIG. 8A shows an example of the customizing data 76 of No. 1 (user “abiko”), and FIG. 8B shows an example of the customizing data 76 of No. (user “biwako”). As the customizing data 76, in a manner of being associated with each function, “graphic data name”, “setting value display order data name” and “place information” are registered. “Graphic data name” designates the graphic data (image data) 71 that determines the view component for each function. For example, when five view components (i.e., five display modes of a view component) are prepared for the function “color selection”, five items of graphic data 71 are prepared, correspondingly. In the example of FIG. 8A, the graphic data name of color selection is “ColorSelect1” from among the five items of graphic data 71. The other four items of graphic data are, for example, ColorSelect2 through ColorSelect5.

In the examples of FIGS. 8A and 8B, the graphic data names of “color selection” of No. 1 and “color selection” of No. 2 are different from one another. Therefrom, it is seen that the users “abiko” and “biwako” have selected the different views for color selection. On the other hand, for the function of “size change”, the graphic data names of No. 1 and No. 2 are the same, i.e., “Magnification1”. Therefrom, it is seen that the users “abiko” and “biwako” have selected the same view for size change. Thus, “view component” means a view in which no setting values (setting information) have been disposed (corresponding to “display component”).

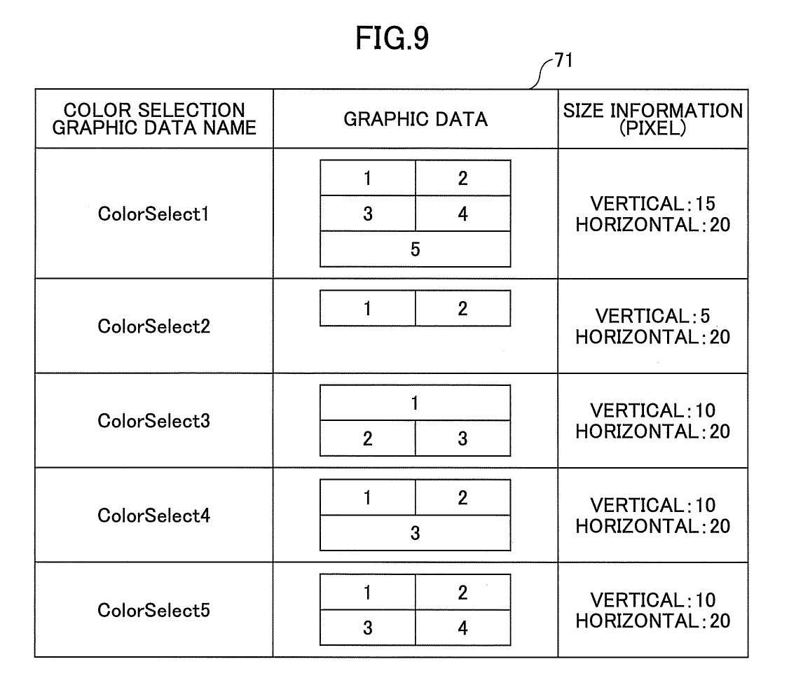

FIG. 9 schematically illustrates one example of the graphic data 71 for the function “color selection”. In FIG. 9, “graphic data” and “size information” are registered as being associated with “graphic data name”. In the case of the function “color selection”, a user can select from five views (i.e., five display modes of a view). Therefore, as being associated with “ColorSelect1” through “ColorSelect5”, respective items of graphic data (view's shape, size and so forth) are registered. Each view component (i.e., a display component in each display mode) has one or more areas, and the areas are given numbers (1 through 5) that identify the areas. In the example of FIG. 9, the graphic data 71 “ColorSelect1” can display five setting values (1-5), the graphic data 71 “ColorSelect2” can display two setting values (1-2), each of the graphic data 71 “ColorSelect3” and “ColorSelect4” can display three setting values (1-3), and the graphic data 71 “ColorSelect5” can display four setting values (1-4), as shown in FIG. 9.

As described later, when a user associates the setting values (or the priority order thereof) with the numbers of respective areas in the view component, the function UI control part 66 disposes the setting values at the respective areas. The setting values are, for example, “monochrome”, “full color”, “two colors”, “single color” and “automatic color selection” (see FIG. 2C). Although not shown, the setting values may include an icon “∴”, for example. Thereby, the view selection screen 203 shown in FIG. 2B, for example, is generated.

Further, in the graphic data 71 of FIG. 9, the size information (in units of pixels) is registered for each view component (i.e., each display mode). For example, a vertical length of “ColorSelect1” is 15 pixels, and a horizontal length thereof is 20 pixels. The display apparatus 100 uses the size information, and displays a closing line (border) or such, which encloses a user-selected view (user-selected display mode of a view).

It is noted that, although the applications 51 are different, the functions of the operating screen 201 may be displayed in common, and therefore, the graphic data name may be the same for the same function.

Returning to FIGS. 8A and 8B, “setting value display order data name” is a name of the setting value display order data that registers the display order of the setting values. That is, the setting value display order data 72 registers the priority order of the respective setting values in the view (display mode) (graphic data name) selected by the user.

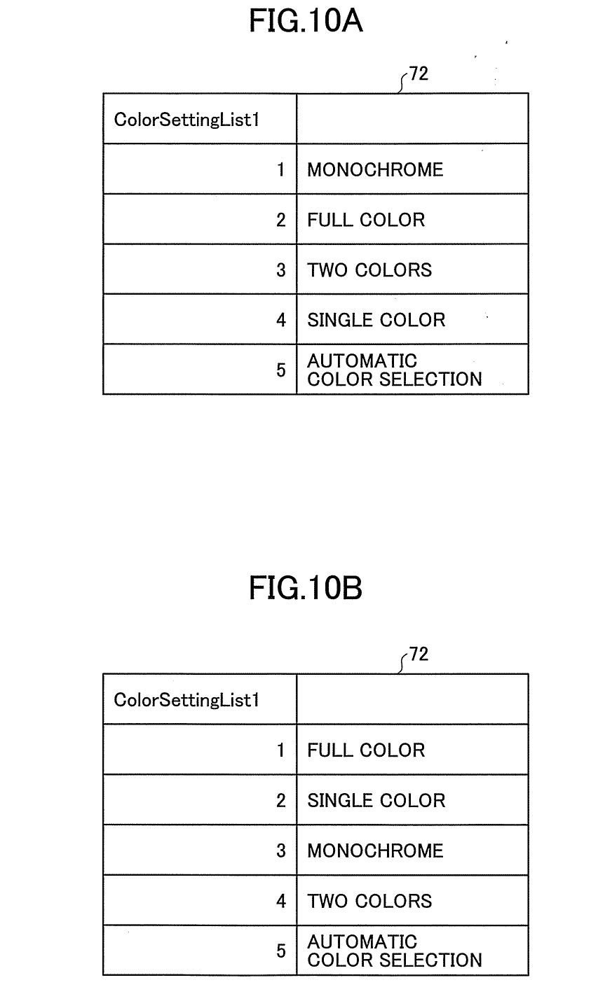

FIGS. 10A and 10B show examples of the setting value display order data 72. FIG. 10A shows the setting value display order data 72 for the user “abiko” before customizing (before a change of a display order), and FIG. 10B shows the setting value display order data 72 for the same user “abiko” after the customizing (after the change of the display order). According to FIG. 9A, in the graphic data 71 of “ColorSelect1”, maximum five setting values can be registered, and therefore, in the setting value display order data 72 of FIGS. 10A and 10B, five setting values are registered. The numerals 1 through 5 in the column of “ColorSettinglist1” show the priority order selected by the user (or, may be an initial display order). It is noted that the priority order also shows the numbers respectively identifying the setting values.

The setting value display order data 72 is registered for each user and for each function. Further, it is possible to provide a configuration in which the setting value display order data 72 may be registered further for each view (each display mode), and thus, may be registered for each user, each function and each view (each display mode). In the former case, the setting value display order data 72 is common among the views (display modes) for the function. However, since the numbers identifying the areas are associated with the respective areas of each of the view components, the setting values can be disposed according to the priory order even when the view component (display mode) becomes different. It is noted that the setting value display order data 72 that is common among the respective users may be registered as a default one.

Returning to FIGS. 8A and 8B, “place information” designates a place of disposing the view on the operating screen 201. “Place information” designates, for example, the position of the top left corner of the view in pixel units. In the example of FIG. 8A, for the user of No. 1, the place of the view for “color selection” is (Cx1, Cy1), and the place of the view for “size change” is (Mx1, My1).

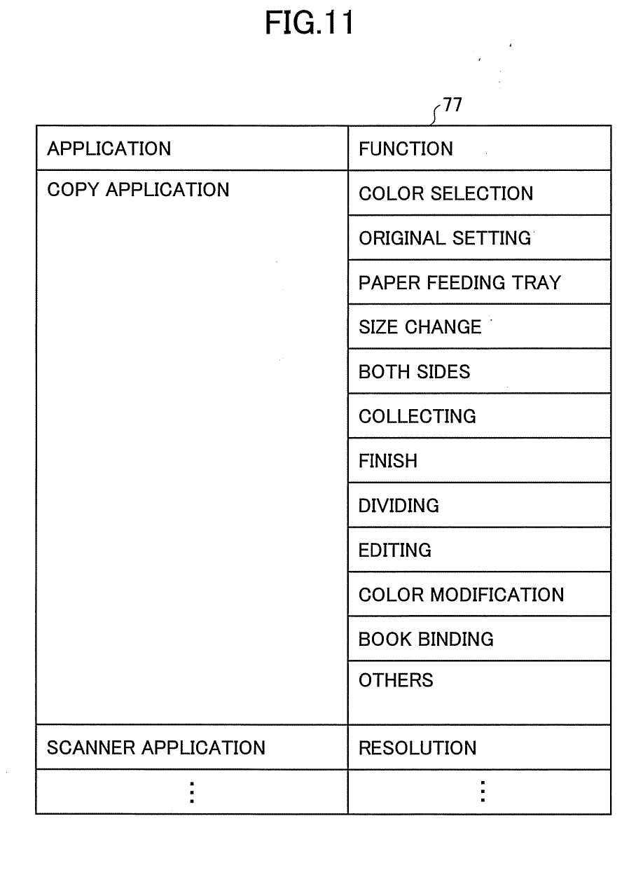

FIG. 11 shows one example of the install data 77. In the install data 77, the functions installed in the image forming apparatus 200 are registered for each of the applications 51. When the function name is given, the graphic data name of the function is obtained from the customizing data 76, and therefore, when a user selects the function, the view component (display mode) for the function, such as those shown in FIG. 9, can be determined through the graphic data name. It is noted that, for the applications 51 that are different, the same function is registered in common.

### [Overall Procedure of Customizing]

FIG. 12 shows a transition of screens displayed on the operation panel 11 when a user customizes the UI.

Immediately after the image forming apparatus 200 is started up, or when a user presses the copy key 112 from the operation panel 11, the OCS 37 detects this state and notifies the SCS 40. Thereby, the SCS 40 displays the operating screen 201 for the copy application 31 shown in FIG. 12. Thus, the SCS 40 can display initial screens of the applications 51 as shown in FIG. 12 for each of the applications 51. In the case of the copy application 31, the operating screen 201 of “easy copy” and the operating screen 201 of “detailed copy” are prepared. Customizing according to the embodiment can be preferably applied to any of these operating screens 201. The number of functions displayed in a form of a list of the operating screen 201 of “detailed copy” is larger than that of the operating screen 201 of “easy copy”. A user can select any one of the operating screens 201 of “easy copy” and “detailed copy” by selecting a tab. Below, description will be made for the example of the operating screen of “easy copy”.

The operating screen 201 of “easy copy” has a function list part 2012 as a main part, and a setting part 2011 and a bibliographic item display part 2013. Each of functions shown in the function list part 2012 is displayed in a form of one view, and the view can be customized. In one view, setting values that can be directly selected are displayed. For example, for the function “color selection”, two setting values “monochrome” and “full color” are selectably displayed. For the function “paper feeding tray”, only one setting value “tray 1” is selectably displayed. In contrast thereto, for the function “size change”, one setting value is selectable from among five setting values “141%”, “same size”, “8×13→A4, B4JIS→A4”, “8×13→A4, B4JIS→A4”, and “paper-size-selecting size change”.

However, depending on particular users, the setting value “monochrome” may be selected in many cases for the function of “color selection”, or, only the setting value “same size” may be almost always selected for the function “size change”. The display apparatus 100 according to the embodiment enables each user to customize, for each function, setting values to be displayed, the number of setting values to be displayed, and so forth.

It is noted that, in FIG. 12, on the operating screen 210, plural views are displayed depending on the particular functions. For example, for a function “both sides”, a setting value “one side→both sides” and a setting value “both sides→both sides” are displayed as respective views. Similarly, for a function “finish”, a setting value “one place to the top left” and a setting value “two places to the left” are displayed as respective views. Whether one or more views are displayed for the same function in the function list part 2012 is previously determined. The setting values for the same function are thus separated into the plural views in consideration that a use can easily select the setting values or user can easily use the views. Therefore, a design of the operating screen 201 may be carried out such that, for each of the functions “both sides” and “finish”, the plural views are united into one view, or, for the function “size change”, the respective setting values may be displayed in different views.

A user who wishes to customize setting values or the number of setting values to be displayed for each function presses a “general menu” key in the setting part 2011. As a result of this key being pressed, a screen (not shown) is displayed to receive various settings concerning the image forming apparatus 200, and, when the user presses a “customizing key” (not shown) from the displayed screen, a function list screen 202 shown in FIG. 12 is displayed.

FIG. 12 shows one example of the function list screen 202 showing a list of functions that can be customized in the copy application 21. The customizing function selecting part 62 shown in FIG. 6 reads the install data 77 of the copy application 31, and displays the function list on the function list screen 202 as shown in FIG. 12. When the user operates a scroll bar SB, further functions are displayed. In FIG. 12, various functions including setting values that can be set by users are displayed in the form of the list. Another function that is also usable from an application of the applications 51 other than the copy application 31, if any, is also displayed when an operating screen 201 for the other application is customized.

Next, in a case where the user presses a “color selection” from the function list of the screen 202, a view selection screen 203 shown in FIG. 13 is displayed. The view information selecting part 63 of FIG. 6 reads the graphic data 71 and displays the view selection screen 203 such as that shown in FIG. 13. As described above with reference to FIG. 9, the five items of graphic data 71 are prepared for the function “color selection”, and therefore, five views are displayed in the screen 203 of FIG. 13. In consideration of which of the setting values is used frequently for the function of “color selection”, the user selects a view from among the five views (or selects a display mode from among the five display modes) including the setting value. After the selection, when the user presses a “next” key 2031 of the screen 203, a display order selection screen 204 shown in FIG. 13 is displayed.

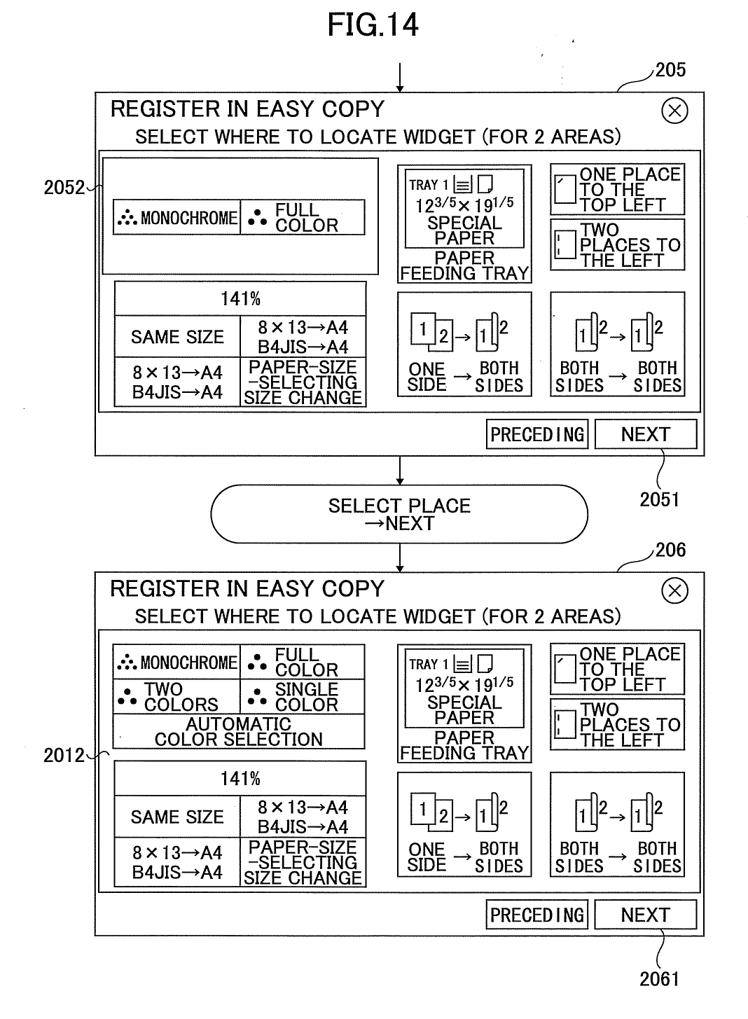

It is noted that, after the selection of the view, the user may display a disposing place selection screen 205 of FIG. 14 instead of the display order selection screen 204. In this case, the screen disposing place selecting part 64 displays a candidate of a most preferable place to dispose the view on the operating screen 201 by using a closing line 2052 or such.

FIG. 13 shows one example of the display order selection screen 204 used for customizing dispositions of the setting values in the view component. On the screen 204 of FIG. 13, on the left side, numerals 1 through 5 are displayed at respective areas of the view component. The numerals 1 through 5 are numbers used for identifying the areas, and are numerals corresponding to the numerals 1 through 5 (priority order) of “ColorSettingList1” of the setting value display order data 72 (see FIG. 10A).

On the right side of the screen 204 of FIG. 13, the setting values are displayed as being associated with the numerals 1 through 5, respectively. On the right side of the setting values, solid triangle marks 2042 each of which indicates the upward or the downward direction are displayed, respectively. When the user presses the triangle mark 2042 indicating the downward direction, the corresponding setting value moves downward by one item, while the setting value that originally exits at the moving destination moves upward by one item. When the user presses the triangle mark 2042 indicating the upward direction, the corresponding setting value moves upward by one item, while the setting value that originally exits at the moving destination moves downward by one item. The user can dispose desired setting values at desired areas respectively, by repeating such an operation while reading the numerals of the respective areas on the left side.

When the user presses a “next” button 2041 on the screen 204, the disposition order on the right side of the screen 204 (FIG. 13) is stored as the setting value display order data 72. Further, the disposing place selection screen 205 of FIG. 14 is displayed.

FIG. 14 shows one example of the disposing place selection screen 205 used when the user determines a disposition of the view component (display mode) selected from the screen 203 of FIG. 13. The screen disposing place selecting part 64 displays a candidate of the most preferable place on the operating screen 201 by using a closing line 2052 or such. For the closing line 2052, the size of the view is considered. On the screen 205 of FIG. 14, the place at which the view of the function “color selection” exists before the customizing is displayed as the candidate. It is noted that the user can select a place other than the candidate. In a case where there is no view at the place selected by the user other than the candidate, the screen disposing place selecting part 64 disposes the customized view of color selection at the place selected by the user. On the other hand, in a case where the place selected by the user other than the candidate has been already used by a view of another function and there is no space to further dispose the customized view of color selection, the screen disposing place selecting part 64 may delete the other view of color selection from the selected place, and disposes the customized view of color selection at the selected place.

When the user presses a “next” key 2051 on the screen 205 after selecting the place of the candidate, the screen disposing place selecting part 64 stores the disposing place for each view in the customizing data 76. Further, a customizing result confirmation screen 206 of FIG. 14 is then displayed.

FIG. 14 shows one example of the customizing result confirmation screen 206 in which the view component of the color selection and the dispositions of the setting values in the view component are customized. As shown in the screen 206 of FIG. 14, instead of the view of the function of color selection shown in the screen 201 of FIG. 12, the view (display mode) selected from the screen 203 of FIG. 13 is disposed. After the user confirms the screen 206 of FIG. 14, and presses a “next” key 2061 on the screen 206, the operating screen 201, for example, is returned.

Thus, a user can select a combination and/or the number of setting values to be displayed for each function, and further, can customize dispositions of the setting values. Selection of a view (display mode) and selection of disposing order can be carried out by a user's visual operation, and therefore, it is possible to avoid a situation in which, after customizing, a desired setting value cannot be used, for example.

### [Operation Procedure]

Below, a procedure of FIG. 12 will be described in details with reference to a sequence diagram.

### <Operating Screen 201→Function List Screen 202>

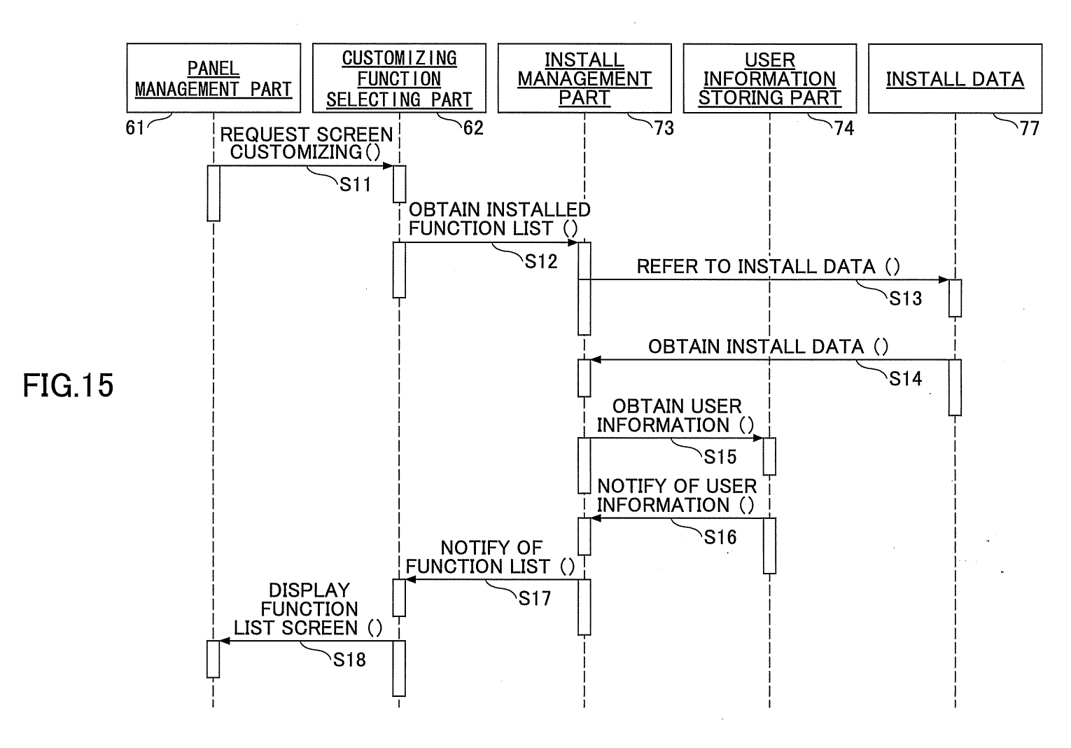

FIG. 15 is one example of a sequence diagram showing a procedure of displaying the function list screen 202 shown in FIG. 12 from the operating screen 201 of easy copy of FIG. 12. The sequence diagram of FIG. 15 starts from the screen (not shown) that is displayed in response to the “general menu” key being pressed by a user from the screen 201 of FIG. 12. It is assumed that the user has selected the copy application 31, for example. Further, when the operating screen 201 of FIG. 12 is displayed, the user has logged into the image forming apparatus 200. Therefore, the panel management part 61 holds the user name and identification information (referred to as an application name, hereinafter) of the application 51 (copy application 31).

When the user presses a “screen customizing” key (an operating key, not shown) displayed on the screen (not shown) displayed in response to the “general menu” key being pressed by the user on the operation panel 11, the panel management part 61 notifies the customizing function selection part 62 of the “screen customizing” key having been pressed. A parameter (argument) thus reported is the user name and the application name.

As a result, the customizing function selecting part 62 receives a customizing request for the operating screen 201 (step S11). That is, the customizing function selecting part 61 receives the customizing request for the operating screen 201 as a request to call the function list screen 202 shown in FIG. 12.

Then, in order to generate the function list screen 202 of FIG. 12, the customizing function selecting part 62 notifies the install management part 73 of a request to obtain a list of functions that have been installed (step S12). The customizing function selecting part 62 at this time notifies the install management part 73 of the user name and the application name.

In order to determine the functions that have been installed for the application 51 (copy application 31), the install management part 73 then refers to the install data 77 by using the application name as a key (step S13). Thus, the install management part 73 can obtain install data such as “color selection”, “original setting” and so forth (functions) that have been installed for the copy application 31 (step S14).

Next, in order to determine functions for which usage by the user who has logged in is prohibited, the install management part 73 requests the user information from the user information storing part 74 by using the user name as a key (step S15). The information that the install management part 73 requests is “usage restriction function”, and therefore, only the information of “usage restriction function” itself may be requested. The user information storing part 74 notifies the install management part 73 of the user information of the user who has logged in (step S16).

The install management part 73 deletes the functions for which usage by the user who has logged in is prohibited by the usage restriction function, and notifies the customizing function selecting part 62 of the list of installed functions (install data) (step S17). Thus, only the functions that the user can use are left to be able to be customized; therefore, the user need not determine whether the functions can be used, and thus, it is possible to improve usability.

The customizing function selecting part 62 receives the notification from the install management part 73, generates the function list screen 202 shown in FIG. 12 that displays the respective function names of the installed data, and displays the screen 202 on the operation panel 11 (step S18). As shown in the screen 202 of FIG. 12, the respective function names are displayed in a form of cells.

Thus, the customizing function selecting part 62 can display the function list screen 202 of FIG. 12 for each of the applications 51 for each user.

### <Function List Screen 202→View Selection Screen 203 (Method 1)>

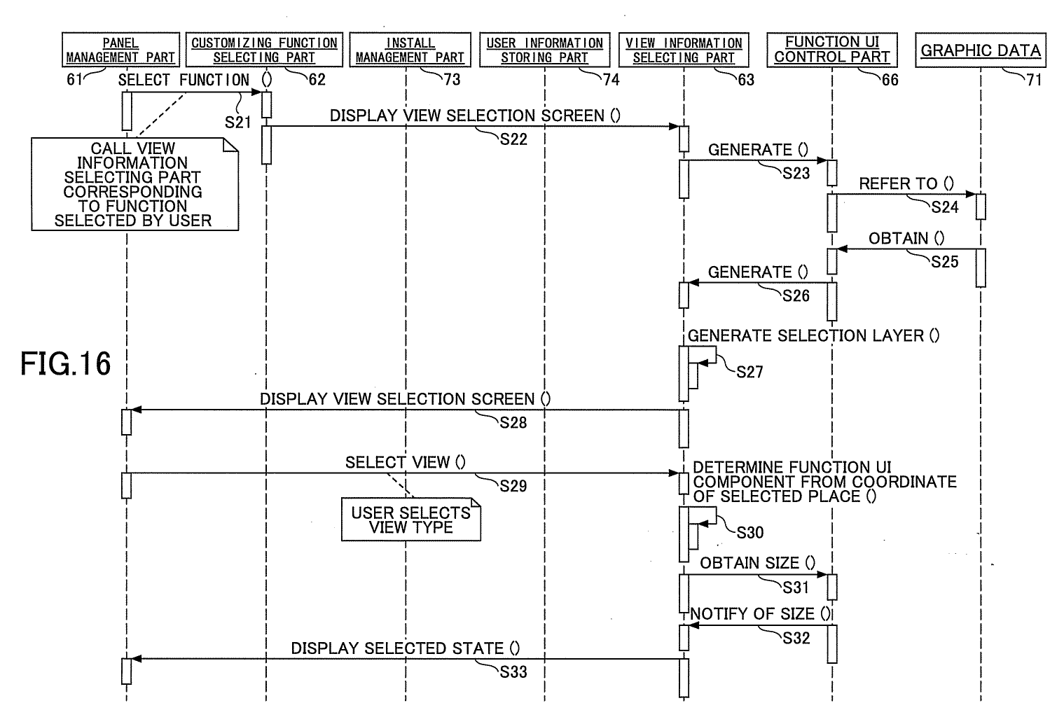

FIG. 16 shows one example of a sequence diagram showing a procedure of the view information selecting part 63 and so forth displaying the view selection screen 203 of FIG. 13 from the function list screen 202 of FIG. 12. It is noted that there are two methods to process the selected view (display mode), and thus, the respective methods will be described, one by one, in sequence.

In response to the user's selecting a function to be customized from the function list screen 202 of FIG. 12, the panel management part 61 notifies the customizing function selecting part 62 of identification information of the selected function or position information of a pressed position (step S21). In either case, the customizing function selecting part 62 obtains the function that the user has selected.

Next, in order to display views (display modes) corresponding to the selected function, the customizing function selecting part 62 requests the view information selecting part 63 to display the view selection screen 203 (step S22). At this time, a parameter to be used is the function name.

Then, the view information selecting part 63 corresponding to the function is called, and the called view information selecting part 63 generates the function UI control parts 66 corresponding to the function (step S23). The function UI control parts 66 provide a function to display (generate) views (display modes) that can be displayed for each function. It is noted that “generates the function UI control parts 66” means generation of instances in an object-oriented language, and, for example, corresponds to generation of instances of the function UI control parts 66 from a predetermined “class”. The function UI control part 66 is generated for each view (each display mode). For example, in a case where five views (five display modes) can be selected by a user for one function, the five function UI control parts 66 are generated.

Each of the function UI control parts 66 refers to the graphic data 71 (step S24). Each function UI control part 66 thus obtains the graphic data 71 for each view component (each display mode) (step S25). Each function UI control part 66 then reads the graphic data 71 for each view component (each display mode), from FIG. 9, for example, based on the function name.

Each function UI control part 66 generates each view component (each display mode) by disposing the respective setting values described in a program (i.e., previously determined default) at the respective areas of the graphic data 71 (step S26). Since the setting values that are described, not in the setting value display order data 72, but in the program, are disposed in the respective areas, the disposing order of the setting values for each view component (display mode) of the view selection screen 203 is common throughout all the users.

Further, the setting values to be disposed at the respective areas of each view component (each display mode) of the view selection screen 203 may be read from the setting value display order data 72. In this case, it is possible to reflect the setting value display order data 72 finally customized by the user on each view component (each display mode) of the view selection screen 203. The function UI control part 66 can read the setting value display order data 72 of FIG. 10A or 10B as a result of obtaining the user name.

Next, the view information selecting part 63 generates a selection layer (not shown) for each view (each display mode) (step S27). The selection layer is used for taking the user's operation for selection of the view (display mode) out of the system (for example, the SCS 40) that controls, not customizing screens, but regular operations. The selection layer is, for example, realized by a description in a program. The view itself generated by the function UI control part 66 is, as shown in the screen 201 of FIG. 12, displayed also on the operating screen 201 that the user operates (not for customizing the screen but as a regular operation). Therefore, when the user merely selects the setting value of the view, a corresponding predetermined event (color selection or such) is received by the image forming apparatus 200 not for customizing the screen but as a regular operation in response to the user's pressing the setting value of the view.

Therefore, the user cannot customize the operating screen 201. In order to enable the user to customize the operating screen 201, the view information selecting part 63 generates the above-mentioned selection layer. A size of the selection layer is similar to the size of the view, or the selection layer is somewhat larger than the view. The selection layer may be made of a transparent button or such (which needs to be a method that receives a user's operation). Therefore, the user can select the entirety of the view (display mode) without being aware of the selection layer. The event occurring as a result of the selection layer being pressed is executed earlier than (in preference to) the system receiving the event, and therefore, the view information selecting part 63 can take the user's operation out of the system.

The view information selecting part 63 displays the view selection screen 203 in which the selection layer is superposed on the view generated as image data on the operation panel 11 (step S28). Thus, the view selection screen 203 of FIG. 13 is displayed.

Next, in response to the user's pressing (selecting) the desired view (display mode), the panel management part 61 notifies the view information selecting part 63 of the position information of the selected view (display mode) (step S29). Then, the view information selecting part 63 determines the view (display mode) selected by the user based on the position information (step S30). It is noted that the above-mentioned processes are carried out so that the view (display mode) selected by the user may be indicated by using the closing line 2032 or such on the operation panel 11.

The view information selecting part 63 requests the function UI control part 66 to report the size information of the determined view (display mode) (step S31). The size information is held in the graphic data 71 (described in the instance), and therefore, the function UI control part 66 already knows the size information (vertical length and horizontal length) of the view. The function UI control part 66 notifies the view information selecting part 63 of the size information of the view (step S32).

The view information selecting part 63 displays the closing line 2032 that indicates the selected state on the operation panel 11 (step S33). In the screen 203 of FIG. 13, the closing line 2032 indicating the selected state is displayed to enclose the view (display mode) selected by the user. Instead of thus displaying the closing line 2032, brightness of the selected view may be increased, or the selected view may be displayed with a changed color.

Thus, by disposing the selection layer, it is possible to receive the user's customizing operation even in the case where the views the same as those displayed for regular operations are displayed.

### <Function List Screen 202→View Selection Screen 203 (Method 2)>

A second method (a procedure without generating the selection layer) of the above-mentioned procedure of displaying the view selection screen 203 shown in FIG. 13 from the function list screen 202 shown in FIG. 12 will be described.

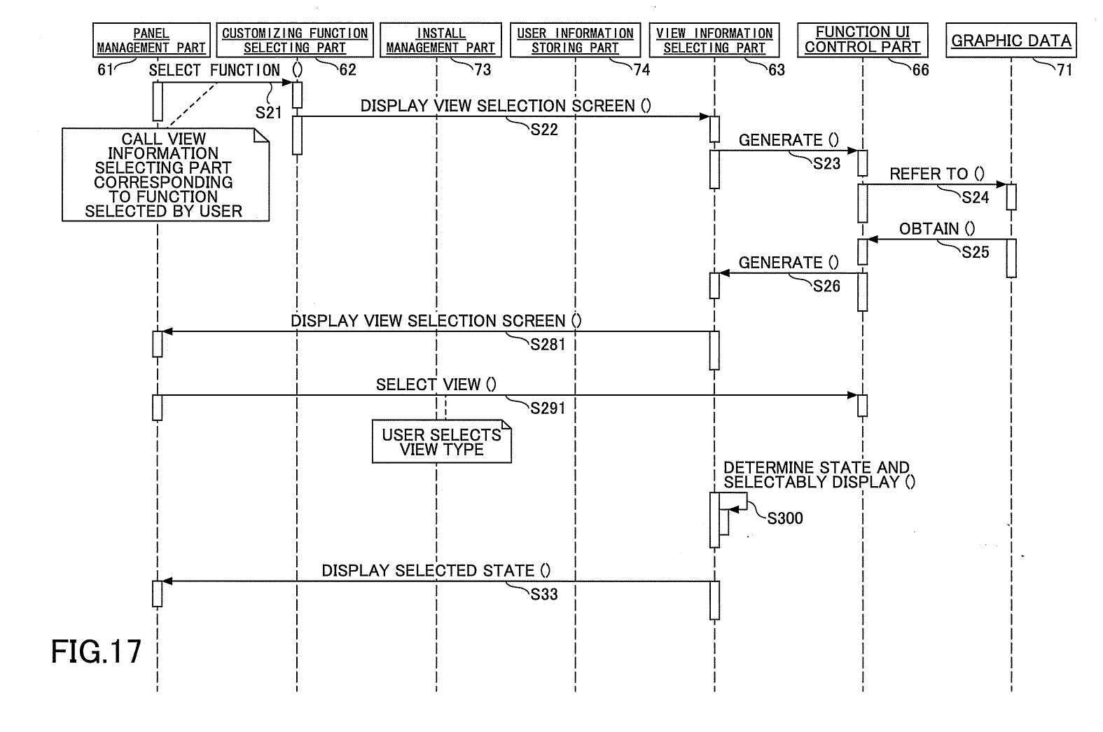

FIG. 17 shows one example of a sequence diagram showing a procedure of the view information selecting part 63 and so forth displaying the view selection screen 203 of FIG. 13 from the function list screen 202 of FIG. 12.

In response to the user's pressing the function to be customized from the function list screen 202 of FIG. 12, the panel management part 61 notifies the customizing function selecting part 62 of the identification information of the selected function or the position information of the pressed position (step S21). In either case, the customizing function selecting part 62 obtains the function that the user has selected.

Next, in order to call the view information selecting part 63 corresponding to the function, the customizing function selecting part 62 requests the view information selecting part 63 to display the view selection screen 203 (step S22). At this time, a parameter to be used is the function name.

Then, the view information selecting part 63 corresponding to the function is called, and the called view information selecting part 63 generates the function UI control parts 66 corresponding to the function (step S23). The function UI control parts 66 display views (display modes) that can be displayed for each function. It is noted that “generates the function UI control parts 66” means generation of instances in an object-oriented language, and, for example, corresponds to generation of instances from the function UI control parts 66 as a “class”. The function UI control part 66 is generated for each view (each display mode). For example, in a case where five views (five display modes) can be selected by a user for one function, the five function UI control parts 66 are generated.

Each of the function UI control parts 66 refers to the graphic data 71 (step S24). Each function UI control part 66 thus obtains the graphic data 71 for each view component (each display mode) (step S25). Each function UI control part 66 then reads the graphic data 71 for each view component (each display mode), from FIG. 9, for example, based on the function name.

Each function UI control part 66 generates each view component (each display mode) by disposing the respective setting values described in a program (i.e., previously determined default) at the respective areas of the graphic data 71 (step S26). The setting values may be determined from the setting value display order data 72. The function UI control part 66 can read the setting value display order data 72 of FIG. 10A or 10B as a result of obtaining the user name.

Next, the view information selecting part 63 displays the view selection screen 203 in which the views (display modes) generated as image data are disposed, on the operation panel 11 (step S281), without generating the selection layer. Thus, the view selection screen 203 of FIG. 13 is displayed.

Next, in response to the user's pressing a desired one of the views (display modes), the panel management part 61 notifies the function UI control part 66 of the position information of the selected view (display mode) (step S291). In the method 2, it is determined whether the operation screen 201 is being customized or the image forming apparatus 200 is being used for regular operations other than screen customizing, by the following process.

Specifically, the function UI control part 66 determines the state of the image forming apparatus 200 (step S300).

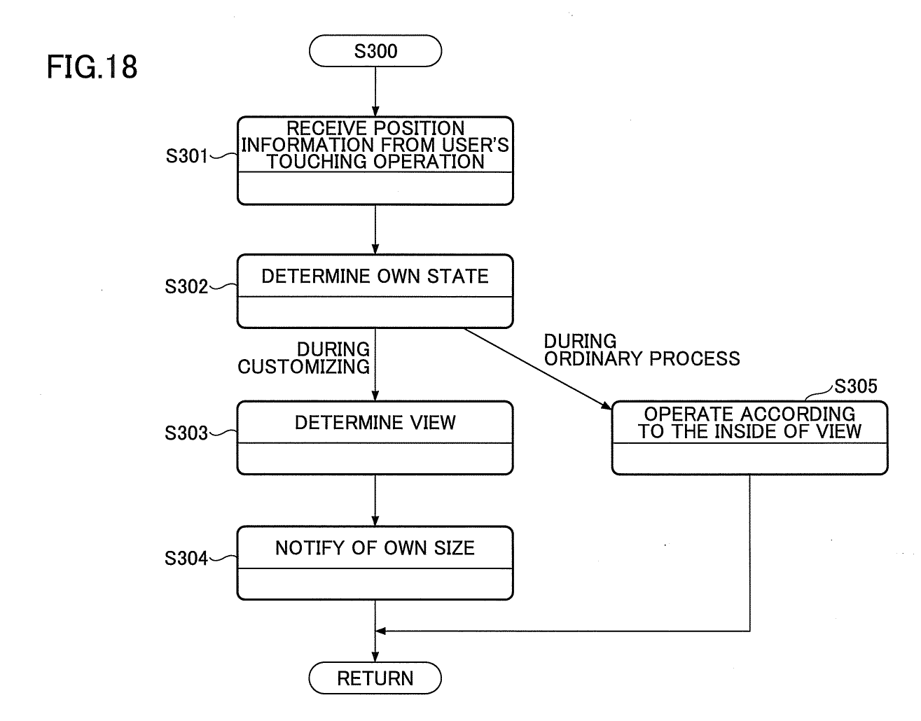

FIG. 18 shows one example illustrating the process of step S300 in detail. First, the function UI control part 66 receives the position information (step S301). Then, the function UI control part 66 determines the state of the image forming apparatus 200 (step S302). Several methods exist for determining the state of the image forming apparatus 200. For example, the function UI control part 66 reads a flag generated by the customizing function selecting part 62. The customizing function selecting part 62 provides the function that is called during customizing the screen, and therefore, the function UI control part 66 can determine that the image forming apparatus 200 is in the state where the screen is being customized, by determining that the flag indicates that the customizing function selecting part 62 has been started up. Thus, the function UI control part 66 can determine the state of the image forming apparatus 200 by reading the flag generated by the customizing function selecting part 62. Further, the view information selecting part 63 can determine the state of the image forming apparatus 200 by appropriately reading a function or a flag which holds the state of the image forming apparatus 200.

In a case where the function UI control part 66 has determined that the screen is being customized, the function UI control part 66 determines the view selected by the user based on the position information (step S303). In this case, the function UI control part 66 notifies the view information selecting part 63 of the size information of the determined view (step S304).

Further, in a case where the function UI control part 66 has determined that no customizing is being carried out, the function UI control part 66 determines the setting value of the view selected by the user based on the position information (step S305). For example, the function UI control part 66 determines the corresponding one of the setting values, i.e., “monochrome”, “full color”, “two colors”, “single color” and “automatic color selection”. In this case, the function UI control part 66 notifies the system (for example, the SCS 40) of the determined setting value.

Returning to FIG. 17, the view information selecting part 63 displays the selected state on the operation panel 11 (step S33). In the screen 203 of FIG. 13, the closing line 2032 indicating the selected state is displayed to enclose the view (display mode) selected by the user. Instead of thus displaying the closing line 2032, brightness of the selected view may be increased, or the selected view may be displayed with a changed color.

Thus, it is possible to receive the user's customizing operation although the special selection layer is not generated.

### <View Selection Screen 203→Display Order Selection Screen 204>

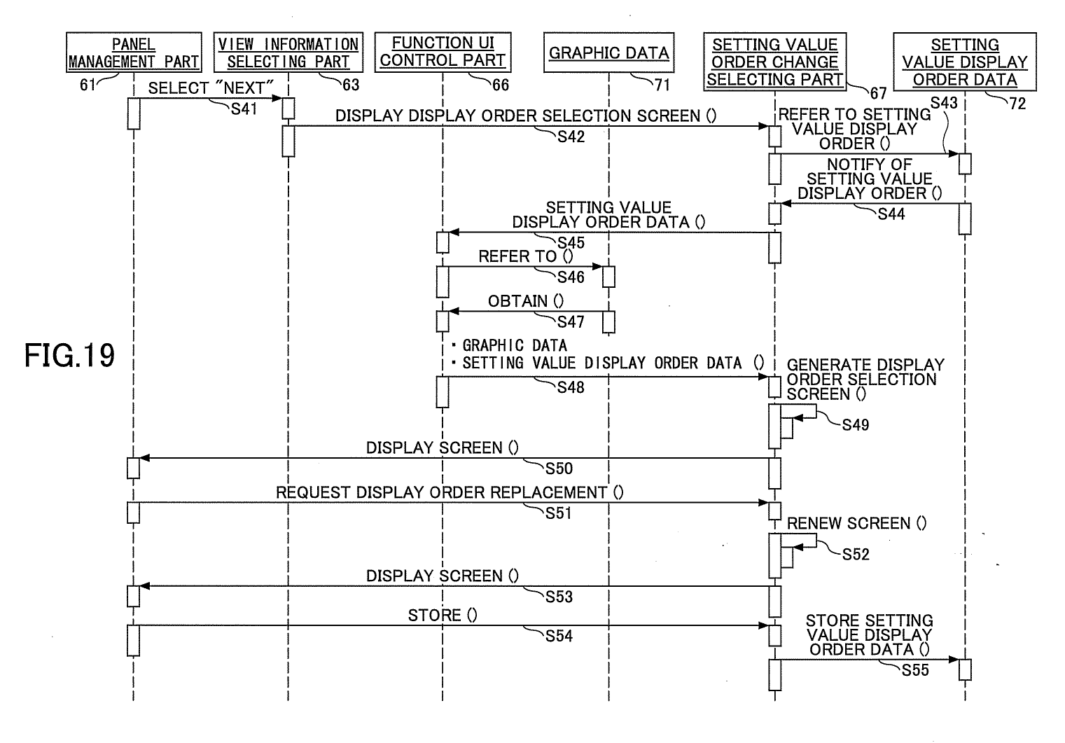

FIG. 19 shows one example of a sequence diagram showing a procedure of the setting value order change selecting part 67 and so forth displaying the display order selection screen 204 of FIG. 13 from the view selection screen 203 of FIG. 13.

After the user selects the view (display mode), the panel management part 61 notifies the view information selecting part 63 that a “next” key 2031 has been pressed, in response to the user's pressing the “next” key 2031 of the screen 203 (step S41). The view information selecting part 63 then notifies the setting value order change selecting part 67 that display of the display order selection screen 204 has been requested (step S42). In this case, the view information selecting part 63 notifies the setting value order change selecting part 67 of the function name selected by the user and the user name. The function name has been reported by the customizing function selecting part 62 to the view information selecting part 63 in step S22.

The setting value order change selecting part 67 refers to the user's setting value display order data 72 for the function by using the user name and the function name as keys (step S43). In a case where the setting value display order data 72 has been registered for each view (display mode), the setting value order change selecting part 67 obtains the identification information of the view (display mode) selected by the user from the view information selecting part. 63, and obtains the user's setting value display order data 72 for the view (display mode). It is noted that, the user may change the display order of the setting values, and therefore, default setting value display order data may be displayed instead of the setting value display order data 72 for each user being displayed. Thereby, the arrangement of the setting values immediately after the display order selection screen 204 is displayed can be one fixed at any time without regard to the user and the customized setting value display order data 72.

The setting value order change selecting part 67 thus obtains the setting value display order data 72 (step S44). Thus, it is possible to obtain the information of the setting values to be preferentially displayed for the function selected by the user who has logged in.

Next, the setting value order change selecting part 67 notifies the function UI control part 66 of the setting value display order data 72 (step S45). The function UI control part 66 refers to the graphic data 71 (step S46). The function UI control part 66 thus obtains the graphic data 71 for the view component (step S47). In the graphic data 71, the areas of each view component are associated with numbers. By means of the above-mentioned process, the view component on the right side of the screen 204 of FIG. 13 can be drawn.

Next, the function UI control part 66 notifies the setting value order change selecting part 67 of the graphic data 71 and the setting value display order data 72 for the view component (step S48). The notification is carried out so that the setting value order change selecting part 67 receives a change in the dispositions of the setting values for the view component.

The setting value order change selecting part 67 generates the display order selection screen 204 of FIG. 13 based on the graphic data 71 and the setting value display order data 72 for the view component (step S49). That is, the view component on the left side of the screen 204 of FIG. 13 is generated from the graphic data 71 and the list on the right side is generated from the setting value display order data 72. Then, the setting value order change selecting part 67 displays the generated display order selection screen 20 on the operation panel 11 (step S50).

The user may move upward or downward the setting values in the setting value display order data 72 by pressing the triangle marks 2042 from the display order selection screen 204 of FIG. 13. Each time when the user presses the triangle mark 2042, the panel management part 61 notifies the setting value order change selecting part 67 of a display order replacement request together with the position information of the pressed position (step S51). The setting value order change selecting part 67 determines the pressed setting value of the setting value display order data 72 and whether the triangle mark 2042 indicating upward or downward has been pressed, based on the position information. Then, based on the determined setting value and triangle mark 2042, the setting value order change selecting part 67 renews the setting value display order data 72.

The setting value order change selecting part 67 generates the view component on the left side of the screen 204 from the graphic data and the list on the right side from the renewed setting value display order data 72 (step S52), in the same manner as that of step S50, and displays the display order selection screen 204 on the operation panel 11 (step S53). The setting value order change selecting part 67 repeats steps S51 through S53 each time when the user presses the triangle mark 2042.

In response to the user's changing the disposing order of the setting values and pressing the “next” key 2041 from the display order selection screen 204, the panel management part 61 notifies the setting value order change selecting part 67 that the “next” key 2041 has been pressed (step S54). In response to this operation, the setting value order change selecting part 67 receives a request to store the setting value display order data 72. Then, the setting value order change selecting part 67 stores the renewed setting value display order data 72 (step S55). Thus, the user can store the setting value display order data 72 for each function (further, for each view (display mode)).

### <Display Order Selection Screen 204→Disposing Place Selection Screen 205→Customizing Result Confirmation Screen 206>

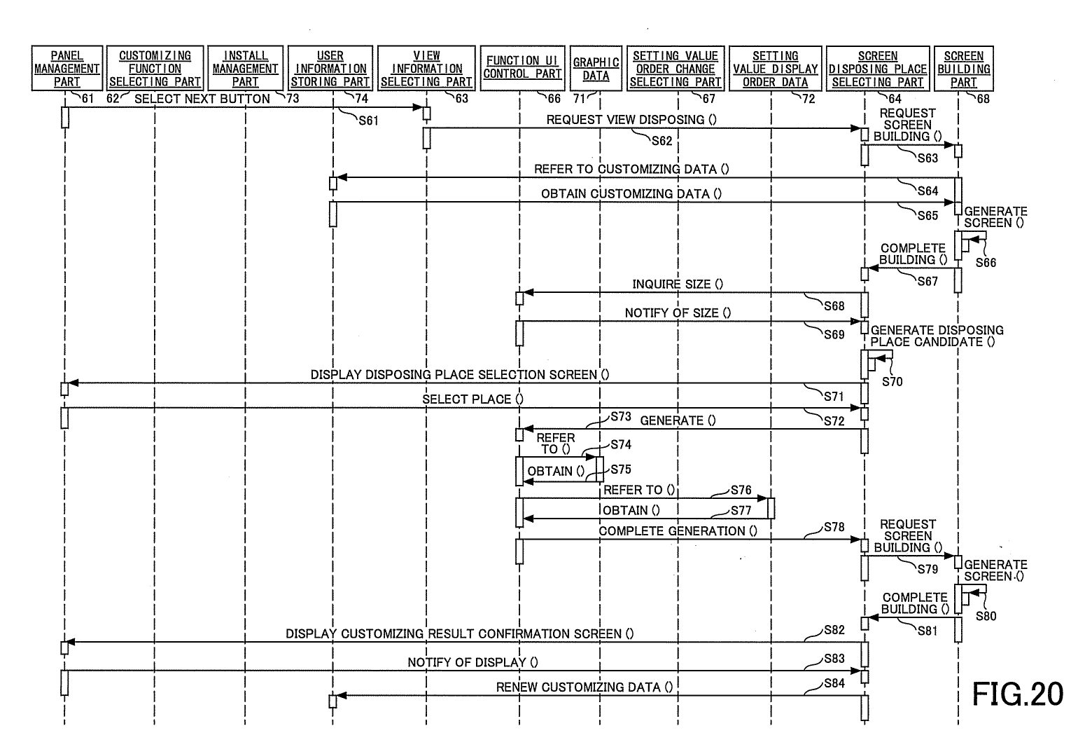

FIG. 20 shows one example of a sequence diagram showing a procedure of the screen disposing place selecting part 64 and so forth displaying the disposing place selection screen 205 of FIG. 14 from the display order selection screen 204 of FIG. 13, and displaying the customizing result confirmation screen 206 of FIG. 14 from the disposing place selection screen 205 of FIG. 14. The sequence diagram of FIG. 20 starts immediately before the “next” key 2041 is pressed from the screen 204 of FIG. 13.

In response to the user's changing the setting value display order data 72 and then pressing the “next” key 2041 from the display order selection screen 204, the panel management part 61 notifies the view information selecting part 63 that the “next” key 2041 has been pressed (step S61). The view information selecting part 63 notifies the screen disposing place selecting part 64 of the identification information of the view (display mode) selected by the user to be customized and the user name, and requests the screen disposing place selecting part 63 to dispose the view (step S62).

The screen disposing place selecting part 64 requests the screen building part 68 to build the screen (step S63). The screen building part 68 has a function of building the operating screen 201 of FIG. 12. The screen building part 68 first builds the screen the same as the screen 201 of FIG. 12 so that the screen including the view of the function to be customized may be disposed on the liquid crystal display part 117 of FIG. 4.

For this purpose, the screen building part 68 refers to the customizing data 76 included in the user information by using the user name as a key (step S64). The screen building part 68 obtains link information for the customizing data 76 of the user who has logged in (step S65). The screen building part 68 can obtain the graphic data 71 and the setting value display order data 72 for each function from the customizing data 76. Further, in a case where the customizing data 76 does not exist, the screen building part 68 builds a predetermined initial setting screen.

The screen building part 68 disposes the setting values indicated by the setting value display order data 72 at the areas of the graphic data 71 of each function, and thus generates the views of the respective functions, disposes the respective views on one screen, and builds the disposing place selection screen 205 (step S66). The disposing places of the respective views are determined for the respective functions in such a manner that the views are disposed preferentially at the places at which the views have been most recently disposed. The place information of the disposing places has been registered in the customizing data 76. The disposing places need not be changed, as a result of the respective views being disposed in such a manner that the largest view (display mode) for each function can be disposed. The screen building part 68 then notifies the screen disposing place selecting part 64 of the completion of the building (step S67).

At this time, the disposing place selection screen 205, which is different from the disposing place selection screen 205 of FIG. 14 in that the closing line 2052 for the function of color selection (“monochrome” and “full color”) is not included, is displayed.

Next, in order to determine a place to dispose the view that has been customized by the user, the screen disposing place selecting part 64 inquires of the function UI control part 66 the size information of the view (step S68). The function UI control part 66 holds the size information of the view, and therefore, the function UI control part 66 notifies the screen disposing place selecting part 64 of the size information of the view (step S69).

Then, based on the size information of the view, the screen place selecting part 64 generates visible information at the disposing place candidate of such a size of enclosing the entirety of the view that the user has customized (step S70). The visible information is, for example, the closing line 2052. The screen disposing place selecting part 64 generates the closing line 2052 generated based on the size information of the view at the place at which the view of the function (color selection) has most recently existed. Plural closing lines determined from the size information may be displayed in such a manner that the plural closing lines do not overlap with each other. The screen the same as the operating screen that the user uses is thus displayed, and therefore, the user can easily determine where to dispose the customized view, and thus, usability improves.

Thus, the screen disposing place selecting part 64 displays the disposing place selection screen 205 generated in step S67 including the closing line 2052 on the operation panel 11 (step S71). Thus, the disposing place selection screen 205 shown in FIG. 14 is displayed. The closing line 2052 shows the candidate of the place at which the customized view is to be disposed. As a result of the place at which the view (display mode) selected by the user can be disposed being displayed to match the size of the view, the user can immediately understand where the view can be disposed, and thus, usability improves.

The user selects the place to dispose the customized view from one or more closing lines 2052 (step S72). The panel management part 61 notifies the screen disposing place selecting part 64 of the position information of the position thus pressed by the user.

In a case where the view of the same function has been already disposed at the place selected by the user or nothing has been disposed at the place selected by the user, the screen disposing place selecting part 64 disposes the customized view at the place selected by the user. In a case where no view of the same function has been disposed at the place selected by the user, and also a view of another function has been disposed at the place selected by the user, the screen disposing place selecting part 64 displays an error message “this place cannot be selected” or such, and again displays the disposing place selection screen 205 of FIG. 14.

In the latter case, the view customized by the user may be disposed at the place selected by the user after the view already disposed at the place selected by the user is removed.

Next, the screen disposing place selecting part 64 generates the function UI control part 66 corresponding to the function (step S73). The function UI control part 66 thus generated is only for the view that the user has customized. The function UI control part 66 refers to the graphic data 71 (step S74). Thus, the function UI control part 66 obtains the graphic data 71 for the view component (step S75).

The function UI control part 66 refers to the setting value display order data 72 by using the user name and the identification information of the view (step S76). The function UI control part 66 disposes the setting values at the respective areas of the view component based on the setting value display order data 72, and thus, generates the view.

The function UI control part 66 notifies the screen disposing place selecting part 64 of the completion of generation of the view (step S78). The screen disposing place selecting part 64 requests the screen building part 68 to build the screen (step S79). The screen building part 68 disposes the setting values indicated by the setting value display order data 72 at the areas of the graphic data 71 of each function, thus generates the views of the respective functions; disposes the generated views according to the place information, and also, disposes the view obtained from the function UI control part 66 at the place selected by the user; and thus, builds the customizing result confirmation screen 206 (step S80). The screen building part 68 notifies the screen disposing place selecting part 64 of the completion of the screen building (step S81).

The screen disposing place selecting part 64 displays the customizing result confirmation screen 206 built by the screen building part 68 on the operation panel 11 (step S82). Thus, the customizing result confirmation screen 206 of FIG. 14 is displayed. The panel management part 61 notifies the screen disposing place selecting part 64 of the completion of the screen display, and as a result (step S83), the screen disposing place selecting part 64 renews the customizing data 76 (step S84). Thus, it is possible to store the disposing place (place information) of each view in the customizing data 76. Thus, the user can dispose the customized view at the appropriate place.

Thus, it is possible to re-dispose the view as in the screen 206 of FIG. 14 from the selection of the view from the screen 202 of FIG. 12. In the display apparatus 100 in the embodiment, the user can select the view for each function, and further, customize the dispositions of the setting values in the view. At the time of selecting the view, the user can select the number and the contents of the setting values, and also, change the dispositions of the setting values. The user can easily carry out the customizing since the setting values for the same function can always be displayed all of a lump. Further, since the dispositions of the setting values can be changed, it is possible to obtain the dispositions that the user can easily use even if the number of the setting values is large.

### [Another Mode]

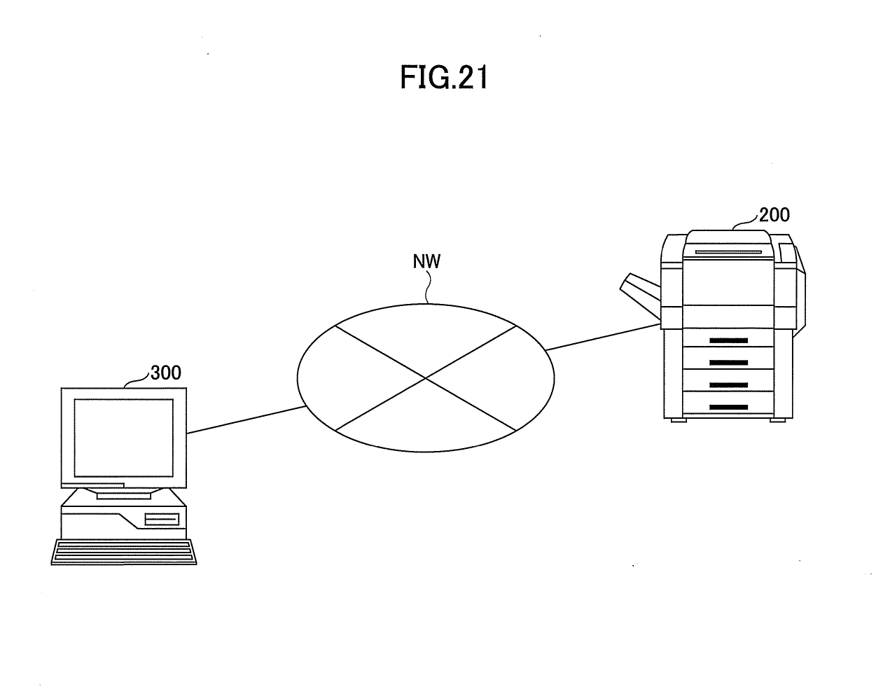

It is noted that in the embodiment, the user directly operates the operation panel 11, and carries out customizing of the screen. However, the user can customize the screen also from a PC (Personal Computer) 300 (see FIG. 21).

FIG. 21 generally shows one example of a configuration of a customizing system in which the image forming apparatus 200 and the PC 300 are connected together. In the system of FIG. 21, a communication network NW is used to connect the image forming apparatus 200 and the PC 300 together. The image forming apparatus 200 has a Web server function, and the PC 300 has a Web browser function. As a result of the user's transmitting the user name and a password to the image forming apparatus 200 from the PC 300, the image forming apparatus 200 authenticates the user, and as a result, the user is allowed to carry out the above-mentioned customizing.

First, the user operates the PC 300, designates an application, and requests the image forming apparatus 200 to transmit a HTML (Hyper Text Markup Language) file of the function list screen 202 of FIG. 12 to the PC 300. In response thereto, the image forming apparatus 200 transmits the HTML file of the function list screen 202.

The Web browser (not shown) of the PC 300 then displays the function list screen 202, and thus, the user selects one function by using a pointing device such as a mouse. The PC 300 transmits the function selection result to the image forming apparatus 200, and requests the image forming apparatus 200 to transmit a HTML file of the view selection screen 203 of FIG. 13 to the PC 300. The image forming apparatus 200 transmits the HTML file of the view selection screen 203 to the PC 300.

The Web browser of the PC 300 then displays the view selection screen 203, and thus, the user selects one view (display mode) by using the pointing device. The PC 300 transmits the view selection result to the image forming apparatus 200 and requests the image forming apparatus 200 to transmit a HTML file of the display order selection screen 204 of FIG. 13. The image forming apparatus 200 transmits the HTML file of the display order selection screen 204 to the PC 300.

The Web browser of the PC 200 then displays the display order selection screen 204, and thus, the user gives a priority order to the respective setting values of the view by using the mouse or a keyboard. In this case, in order to reduce necessary communication time, it is preferable that the numerals 1 through 5 are directly associated with the respective setting values. The PC 300 transmits the setting value display data to the image forming apparatus 200 and requests the image forming apparatus 200 to transmit a HTML file of the disposing place selection screen 205 of FIG. 14 to the PC 300. The image forming apparatus 200 transmits the HTML file of the disposing place selection screen 205 to the PC 300.

The Web browser of the PC 300 then displays the disposing place selection screen 205, and thus, the user selects the place to dispose the view by using the pointing device. The PC 300 transmits the view disposing place selection result to the image forming apparatus 200 and requests the image forming apparatus 200 to transmit a HTML file of the customizing result confirmation screen 206 of FIG. 14 to the PC 300. The image forming apparatus 200 transmits the HTML file of the customizing result confirmation screen 206 to the PC 300.

The Web browser of the PC 300 then displays the customizing result confirmation screen 206, and thus, the user can confirm that the function selected by the user is displayed in the view selected by the user, and also, the setting values in the view are disposed according to the user's customizing.

Thus, the display apparatus 100 in the embodiment may be used together with the PC 300 in a case where the image forming apparatus 200 and the PC 300 can communicate with one another.

The present invention is not limited to the specifically disclosed embodiments, and variations and modifications may be made without departing from the scope of the present invention.

The present application is based on Japanese Priority Application No. 2009-270491 filed Nov. 27, 2009, the entire contents of which are hereby incorporated herein by reference.

What is claimed is:

1. A display apparatus that displays, in a display component for a function that can be called from application software, setting information that can be set for the function, the display apparatus comprising:
a function list display part that displays a list of functions for the application software;
a display information storing part that stores display mode information that indicates one or more display modes for disposing the setting information in the display component for each of the functions;
a first screen generating part that receives the function selected from the list of functions, generates the one or more display modes of the display component based on the display mode information that is associated with the function and is read from the display information storing part while disposing the setting information in the one or more display modes of the display component according to the display mode information, and generates a display mode list screen that displays a list of the one or more display modes of the display component of the function; and
a disposing place candidate display part that receives the display mode selected from the display mode list screen, and displays, based on size information of the display component of the display mode, a disposing place candidate for disposing the display component of the display mode on a screen on which the display component of the display mode is to be disposed.

2. The display apparatus as claimed in claim 1, further comprising:
a setting information storing part that registers disposing position information for disposing each of items of the setting information in the display component; and
a second screen generating part that, in a case of receiving the display mode selected from the display mode list screen, reads from the setting information storing part and displays the setting information that is associated with the selected function received by the first screen generating part, and receives a change of a disposing position for disposing each of the items of the setting information in the display component.

3. The display apparatus as claimed in claim 1, wherein:
the one or more display modes that the first screen display part displays include plural of the display modes in which the number of items of the setting information that can be disposed in the display component for the function is different between the plural display modes.

4. The display apparatus as claimed in claim 2, wherein:
the second screen generating part displays respective items of identification information at positions at which respective items of the setting information are to be disposed in the display component, and displays the respective items of the setting information as being associated with the respective items of identification information.

5. The display apparatus as claimed in claim 4, wherein:
the second screen generating part receives an operation to change correspondences between the items of identification information and the respective items of the setting information, while correspondence between the positions in the display component and the respective items of identification information are fixed.

6. The display apparatus as claimed in claim 1, further comprising
a user information storing part that stores function usage allowing information associated with user identification information that identifies a user, wherein
the function list display part reads the function usage allowing information of the user information storing part and displays the list of functions except functions for which usage is not allowed for the user who logs in.

7. The display apparatus as claimed in claim 1, wherein
in a case where the display component that the first screen generating part generates is also displayed on an operating screen that is used when the application software is executed,
the first screen generating part receives the display mode selected from the one or more display modes of the display component generated based on the display mode information, in preference to the application software receiving the setting information disposed in the display component.

8. The display apparatus as claimed in claim 1, further comprising
flag information indicating that a screen is currently being customized,
wherein
in a case where the display component that the first screen generating part generates is also displayed on an operating screen that is used when the application software is executed,
the first screen generating part reads the flag information, and determines whether the application software is allowed to receive the setting information disposed in the display component, or whether receiving the display mode selected from the one or more display modes of the display component generated based on the display mode information is allowed.

9. The display apparatus as claimed in claim 1, wherein
in a case where the first screen generating part has received the display mode selected from the display mode list screen, the first screen generating part displays visible information that indicates that the display mode has been selected, on the display mode list screen, based on the size information of the display component.

10. The display apparatus as claimed in claims 1, wherein
the disposing place candidate display part determines, as the disposing place candidate of the display component, a place at which the display component of the function selected from the function list screen has been displayed.

11. An image forming apparatus comprising:
the display apparatus claimed in claim 1; and
a printing part that prints an image on a recording medium.

12. A non-transitory computer readable information recording medium storing a program which, when executed by a computer processor of a display apparatus that displays setting information in a display component of a function that can be called by application software, carries out:
displaying a list of the functions for the application software;
receiving the function selected from the list of functions, generating one or more display modes of the display component of the function based on display mode information that is associated with the function and is read from a display information storing part that stores the display mode information that indicates the one or more display modes for displaying the setting information in the display component for each of the functions, while disposing the setting information in the one or more display modes of the display component according to the display mode information, and generating a display mode list screen that displays a list of the one or more display modes of the display component of each of the functions; and
receiving a display mode selected from the display mode list screen, and displaying, based on size information of the display component of the display mode, a disposing place candidate for disposing the display component of the display mode on a screen on which the display component of the display mode is to be disposed.
